(19) United States
(12) Patent Application Publication
(10) Pub. No.: US 2007/0077507 A1
(43) Pub. Date: Apr. 5, 2007

(54) Electrophotographic photoconductor and manufacturing method of electrophotographic photoconductor

(76) Inventors: Junichiro Otsubo, Osaka (JP); Jun Azuma, Osaka (JP); Keiji Maruo, Osaka (JP); Yoshio Inagaki, Osaka (JP); Norio Nakai, Osaka (JP); Kazunari Hamasaki, Osaka (JP); Shiho Okawa, Osaka (JP)

Correspondence Address: Arthur G. Schaier;Carmody & Torrance LLP, P.O. Box 1110, 50 Leavenworth Street, Waterbury, CT, 06721-1110, US

(21) Appl. No.: 11/523,370

(22) Filed: Sep. 19, 2006

(30) Foreign Application Priority Data
Sep. 30, 2005 (JP) 2005-285916
Dec. 13, 2005 (JP) 2005-358406

(51) Int. Cl. G03G 5/14

(52) U.S. Cl. 430/60; 430/131

(57) ABSTRACT

The present invention provides an electrophotographic photoconductor which can reduce the generation of fogging under a high-temperature and high-moisture condition and can be easily manufactured, and a method of manufacturing such an electrophotographic photoconductor. In an electrophotographic photoconductor which includes a support base body, an intermediate layer and a photoconductor layer and a manufacturing method of such an electrophotographic photoconductor, the intermediate layer contains titanium oxide and a binding resin and a ΔL value of the intermediate layer satisfies a following relationship formula (1) or a ΔA value of the intermediate layer satisfies a following relationship formula (2), that is, −5.0≦ΔL≦0 (1) and ΔA≦0.055 (2), wherein the ΔL value is a value which is obtained by subtracting an L value (a parameter value which is measured by a color-difference meter in accordance with JIS Z 8722) which is measured with respect to a single support base body from the L value which is measured in a state that the intermediate layer is formed on the support base body, and the ΔA value is a value which is obtained by subtracting reflection absorbance (a parameter value which is measured by a color-difference meter) which is measured with respect to a single support base body from the reflection absorbance which is measured in a state that the intermediate layer is formed on the support base body.

### BACKGROUND OF THE INVENTION

1. Field of the Invention

The present invention relates to an electrophotographic photoconductor and a manufacturing method of an electrophotographic photoconductor. The present invention relates more particularly to a high-quality electrophotographic photoconductor which is used in an image forming apparatus such as a printer, a copying machine, a facsimile or the like and a manufacturing method of such an electrophotographic photoconductor.

2. Related Art

In an electrophotographic photoconductor provided to an image forming apparatus, a so-called organic photoconductor which is constituted of a charge generating agent which generates charges upon radiation of light, a charge transferring agent which transfers the generated charges, a binding resin which constitutes a layer in which these materials are dispersed or the like has been popularly used. However, the organic photoconductor has following drawbacks.

(1) Along with the application of either one of positive and negative charges to the photoconductor in a charging step, a charge having polarity opposite to the polarity of the charge applied to the photoconductor is generated in a support base body. When an intermediate layer is not provided between the photoconductor and the support base body, the generated charge is injected into a photoconductor layer thus lowering the charging property of the photoconductor.

(2) When the photoconductor layer is directly applied to the support base body by coating, it is difficult to sufficiently adhere the photoconductor layer to the support base body depending on a kind of a binding resin or a coating condition.

(3) When defects such as flaws are present on a surface of the support base body, black points are liable to be easily generated on an image.

Accordingly, to overcome such drawbacks, there has been proposed a method which forms an intermediate layer (a subbing layer) containing a binding resin on a support base body, and a photoconductor layer is formed on the intermediate layer.

For example, there has been proposed an image forming apparatus which includes an electrophotographic photoconductor which includes a support base body, an intermediate layer (a subbing layer) and a photoconductor layer, wherein the intermediate layer contains a phenol-based resin, a polyvinyl acetal resin and an electron transferring organic pigment (for example, see patent document 1).

Further, there has been also proposed an electrophotographic photoconductor which includes a support base body for making a film thickness of an intermediate layer uniform, the intermediate layer and a photoconductor layer, wherein the intermediate layer contains a phenol-based resin and a charge transferring agent having a predetermined molecular weight (for example, see patent document 2).
[Patent Document 1] JP-9-258468A (Claims)
[Patent Document 2] JP-2002-341570A (Claims)

### SUMMARY OF THE INVENTION

[Problems to be Solved]

However, in the image forming apparatus which includes the electrophotographic photoconductor having the intermediate layer described in patent document 1 has a drawback that the intermediate layer is formed by using the electron transferring organic pigment and hence, the electrophotographic photoconductor exhibits poor initial sensitivity and also exhibits poor durability.

Further, although the electrophotographic photoconductor having the intermediate layer which is described in patent document 2 exhibits the excellent electric properties and the excellent image properties, an average molecular weight of a usable charge transferring agent is limited to a range from 400 to 1000 and hence, there has been a drawback that it is difficult to use the charge transferring agent having the average molecular weight outside the range.

Further, the electrophotographic photoconductors which are described in patent document 1 and patent document 2 use a large quantity of a thermosetting phenol-based resin and hence, the color of the electrophotographic photoconductor is liable to be easily faded or made thick thus giving rise to a drawback that it is difficult to determine the uniformity of the thickness or the like in the intermediate layer by using an optical method.

Accordingly, inventors of the present invention have extensively studied these drawbacks and as a result of the studies, the inventors have found out that in an electrophotographic photoconductor which includes a support base body, an intermediate layer and a photoconductor layer, by allowing the intermediate layer to contain titanium oxide and a binding resin and by setting a whiteness of the intermediate layer (ΔL value) which is measured by a color-difference meter in accordance with JIS Z 8722 to a value which falls within a predetermined range or by setting a reflection absorbance (ΔA value) to a value which falls within a predetermined range, even when a surrounding environmental condition is changed, the electrophotographic photoconductor can obtain the excellent image properties.

That is, it is an object of the present invention to provide an electrophotographic photoconductor which can reduce the generation of fogging under a high-temperature and high-moisture condition and can be easily manufactured, and a method of manufacturing such an electrophotographic photoconductor.

[The Means for Solving the Problems]

The present invention provides an electrophotographic photoconductor which includes a support base body, an intermediate layer and a photoconductor layer, wherein the intermediate layer contains titanium oxide and a binding resin and a ΔL value of the intermediate layer satisfies a following relationship formula (1) or a ΔA value of the intermediate layer satisfies a following relationship formula (2), and can overcome the above-mentioned drawbacks by such an electrophotographic photoconductor.
−5.0≦ΔL≦0 (1)
ΔA≦0.055 (2)

ΔL value: a value which is obtained by subtracting an L value (a parameter value which is measured by a color-difference meter in accordance with JIS Z 8722) which is measured with respect to a single support base body from the L value which is measured in a state that the intermediate layer is formed on the support base body.

ΔA value: a value which is obtained by subtracting reflection absorbance (a parameter value which is measured by a color-difference meter) which is measured with respect to a single support base body from the reflection absorbance which is measured in a state that the intermediate layer is formed on the support base body.

That is, by providing the intermediate layer which sets either one of the ΔL value and the ΔA value to a value which falls within a predetermined range, the dispersibility of titanium oxide in the intermediate layer is enhanced thus reducing the generation of fogging under a high-temperature and high-moisture condition in the electrophotographic photoconductor. Further, the preservation stability of coating solution for forming a intermediate layer or the like can be enhanced and hence, it is possible to easily and stably manufacture not only the intermediate layer but also the photoconductor layer thus realizing the economical acquisition of the electrophotographic photoconductor which possesses the stable electric properties.

Here, when the ΔL value of the intermediate layer satisfies the relationship formula (1) and the ΔA value of the intermediate layer satisfies the relationship formula (2), it is possible to further enhance the dispersibility of titanium oxide.

Further, in constituting the electrophotographic photoconductor of the present invention, it may be preferable to set a value (Δa value) which is obtained by subtracting a a value (a parameter value which is measured by a color-difference meter in accordance with JIS Z 8722) of the intermediate layer which is measured with respect to a single support base body from the a value which is measured in a state that the intermediate layer is formed on the support base body to a value which falls within a range from −1.2 to 0.

Due to such a constitution, the number of kinds of parameters which can be measured by a color-difference meter is increased and hence, the dispersibility of titanium oxide can be determined more accurately. Accordingly, the balance between the dispersibility of titanium oxide and the electric insulating property of the intermediate layer is further enhanced thus further reducing the generation of fogging under a high-temperature and high-moisture condition.

Further, in constituting the electrophotographic photoconductor of the present invention, it may be preferable to set a value (Δb value) which is obtained by subtracting a b value (a parameter value which is measured by a color-difference meter in accordance with JIS Z 8722) of the intermediate layer which is measured with respect to a single support base body from the b value which is measured in a state that the intermediate layer is formed on the support base body to a value which falls within a range from 0 to 10.

Due to such a constitution, the number of kinds of parameters which can be measured by a color-difference meter is increased and hence, the dispersibility of titanium oxide can be determined more accurately.

Further, in constituting the electrophotographic photoconductor of the present invention, it may be preferable to set an amount of titanium oxide contained in the intermediate layer to a value which falls within a range from 150 to 350 parts by weight with respect to 100 parts by weight of a binding resin.

Due to such a constitution, the balance between the dispersibility of titanium oxide and the electric insulating property of the intermediate layer is further enhanced thus further reducing the generation of fogging under a high-temperature and high-moisture condition.

Further, in constituting the electrophotographic photoconductor of the present invention, it may be preferable to set an average primary particle size of titanium oxide contained in the intermediate layer to a value which falls within a range from 0.001 to 0.1 μm and it may be further preferable to set the average primary particle size of titanium oxide to a value which falls within a range from 0.001 to 0.015 μm.

Due to such a constitution, it is possible to further enhance the dispersibility of titanium oxide.

Here, the average primary particle size of the titanium oxide can be measured by combining an electron microscope photograph and an image processing apparatus.

Further, in constituting the electrophotographic photoconductor of the present invention, titanium oxide contained in the intermediate layer may be preferably covered with an organosilicone compound.

Due to such a constitution, it is possible to control the water-absorbing property of the titanium oxide and, at the same time, it is possible to further enhance the dispersibility of titanium oxide into the binding resin.

Further, in constituting the electrophotographic photoconductor of the present invention, it may be preferable to set an average molecular weight of the binding resin contained in the intermediate layer to a value which falls within a range from 1000 to 50000.

By setting the average molecular weight of the binding resin to the value which falls within the predetermined range, it is possible to set the viscosity of the coating solution in forming the intermediate layer to a further proper value thus controlling the intermediate layer to have a uniform film thickness. Further, by setting the average molecular weight of the binding resin to such a value which falls within the predetermined range, the obtained intermediate layer can possess the further excellent mechanical strength and adhering property. Accordingly, it is possible to remarkably enhance the abrasion resistance and the durability of the photoconductor layer as well as the intermediate layer.

Further, in constituting the electrophotographic photoconductor of the present invention, it may be preferable to set a thickness of the intermediate layer to a value which falls within a range from 0.1 to 50 μm.

Due to such a constitution, it is possible to allow electrons which are generated in the photoconductor layer to rapidly move to the support base body side and, at the same time, it is possible to further enhance the balance between the adhesion property of the intermediate layer with the photoconductor layer and the mechanical property of the intermediate layer.

Further, in constituting the electrophotographic photoconductor of the present invention, it may be preferable that the electrophotographic photoconductor is a multi-layer type electrophotographic photoconductor in which an intermediate layer, a charge generating layer and a charge transferring layer are sequentially stacked on a support base body.

Due to such a constitution, it is possible to obtain an electrophotographic photoconductor having the excellent sensitive property and durability in the multi-layer type electrophotographic photoconductor which is generally considered to exhibit the large deterioration of electric properties.

Further, according to another aspect of the present invention, there is provided a manufacturing method of an electrophotographic photoconductor which includes a support base body, an intermediate layer and a photoconductor layer, wherein the manufacturing method of the electrophotographic photoconductor includes a step for manufacturing the coating solution for forming a intermediate layer for forming the intermediate layer by dispersing titanium oxide in a binding resin solution containing a binding resin and an organic solvent, and a step for forming the intermediate layer in which a ΔL value of the intermediate layer satisfies a following relationship formula (1) or a ΔA value of the intermediate layer satisfies a following relationship formula (2) by using the coating solution for forming a intermediate layer.
−5.0≦ΔL≦0 (1)
ΔA≦0.055 (2)

ΔL value: a value which is obtained by subtracting an L value (a parameter value which is measured by a color-difference meter in accordance with JIS Z 8722) which is measured with respect to a single support base body from the L value which is measured in a state that the intermediate layer is formed on the support base body.

ΔA value: a value which is obtained by subtracting reflection absorbance (a parameter value which is measured by a color-difference meter) which is measured with respect to a single support base body from the reflection absorbance which is measured in a state that the intermediate layer is formed on the support base body.

Due to such a manufacturing method, the preservation stability of the coating solution for forming a intermediate layer is enhanced and hence, it is possible to easily and stably form the predetermined intermediate layer and, at the same time, it is possible to efficiently manufacture the electrophotographic photoconductor which can reduce the generation of fogging under a high-temperature and high-moisture condition.

### BRIEF DESCRIPTION OF THE DRAWINGS

FIG. 1(a) and FIG. 1(b) are views for explaining the schematic constitution of a single-layer type electrophotographic photoconductor according to the present invention.

FIG. 2(a) and FIG. 2(b) are views for explaining the schematic constitution of a multi-layer type electrophotographic photoconductor according to the present invention.

FIG. 3 is a view for explaining a relationship between a ΔL value of the intermediate layer and a fogging ID value when image forming is performed by using a photoconductor which includes an intermediate body.

FIG. 4 is a view for explaining a relationship between a ΔL value of the intermediate layer and a brightness potential in a photoconductor

FIG. 5 is a view for explaining a relationship between a ΔA value of the intermediate layer and a fogging ID value when image forming is performed by using a photoconductor which includes the intermediate layer.

FIG. 6 is a view for explaining a relationship between a ΔA value of the intermediate layer and a brightness potential of the photoconductor which includes the intermediate layer.

FIG. 7 is a view for explaining the schematic constitution of an image forming apparatus which includes the electrophotographic photoconductor according to the present invention.

FIG. 8(a) and FIG. 8(b) are views for explaining a method for measuring the L value of the intermediate layer.

FIG. 9(a) and FIG. 9(b) are views for explaining a method for measuring the reflection absorbance of the intermediate layer.

FIG. 10 is an image on a surface of the intermediate layer observed using an electron microscope. (example 8)

FIG. 11 is an image on a surface of the intermediate layer observed using the electron microscope. (example 9)

FIG. 12 is an image on a surface of the intermediate layer observed using the electron microscope. (example 10)

FIG. 13 is an image on a surface of the intermediate layer observed using the electron microscope. (comparison example 4)

FIG. 14 is an image on a surface of the intermediate layer observed using the electron microscope. (comparison example 5)

FIG. 15 is an image on a surface of the intermediate layer observed using the electron microscope. (comparison example 6)

FIG. 16 is an image on a surface of the intermediate layer observed using the electron microscope. (comparison example 7)

### BEST MODE FOR CARRYING OUT THE PRESENT INVENTION

[First Embodiment]

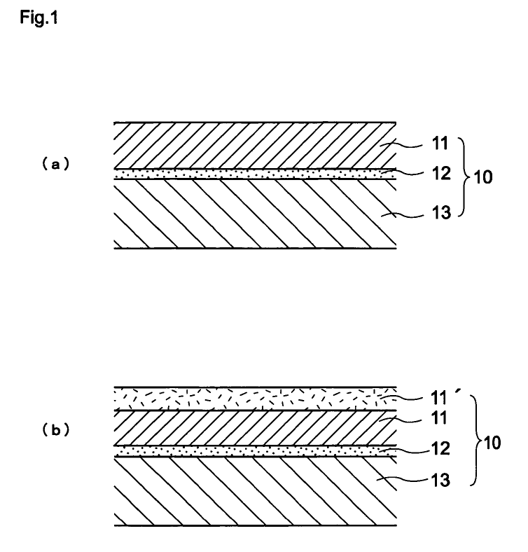

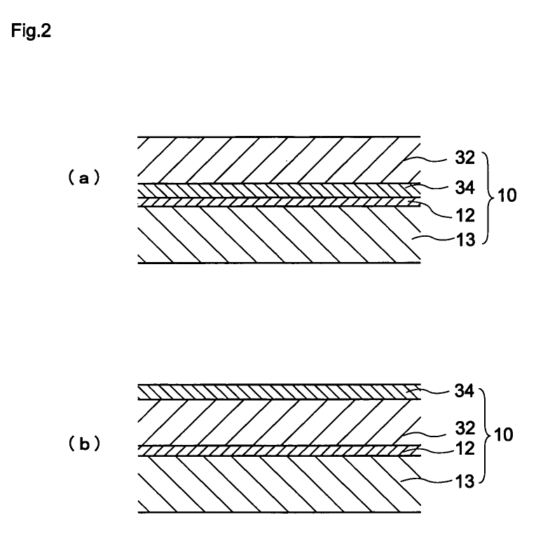

A first embodiment according to the present invention is directed to, as exemplified in FIG. 1(a) and FIG. 1(b), a single-layer type electrophotographic photoconductor 10 which includes a support base body 13, an intermediate layer 12 and a photoconductor layer 11. Alternatively, as shown in FIG. 2(a) and (b) as examples, the first embodiment of the present invention may be a multi-layer type electrophotographic photoconductor 10 which includes a support base body 13, an intermediate layer 12, a charge generating layer 34 and a charge transferring layer 32. Here, the present invention provides the electrophotographic photoconductor in which the intermediate layer 12 in these electrophotographic photoconductors contains titanium oxide and a binding resin, wherein a ΔL value of the intermediate layer satisfies a following relationship formula (1) or a ΔA value of the intermediate layer satisfies a following relationship formula (2). The electrophotographic photoconductor can overcome the above-mentioned drawbacks by such an electrophotographic photoconductor.
−5.0≦ΔL≦0 (1)
ΔA≦0.055 (2)

ΔL value: a value which is obtained by subtracting an L value (a parameter value which is measured by a color-difference meter in accordance with JIS Z 8722) which is measured with respect to a single support base body from the L value which is measured in a state that the intermediate layer is formed on the support base body.

ΔA value: a value which is obtained by subtracting reflection absorbance (a parameter value which is measured by a color-difference meter) which is measured with respect to a single support base body from the reflection absorbance which is measured in a state that the intermediate layer is formed on the support base body.

Here, an electrophotographic photoconductor according to the present invention may be the single-layer type electrophotographic photoconductor in which the intermediate layer and the photoconductor layer are provided on a support base body. However, the electrophotographic photoconductor may preferably be multi-layer type electrophotographic photoconductor in which an intermediate layer, the charge generating layer and the charge transferring layer are sequentially stacked on the support base body.

The reason is that it is possible to obtain an electrophotographic photoconductor having the excellent sensitive property and durability in the multi-layer type electrophotographic photoconductor which is generally considered to exhibit the large deterioration of the electric properties.

Accordingly, hereinafter, the first embodiment of the present invention is explained in detail with respect to a case in which the multi-layer type electrophotographic photoconductor is used as the electrophotographic photoconductor.

1. Support Base Body

The support base body 13 exemplified in FIG. 2 maybe made of a metal material such as cupper, aluminum, nickel or iron or a ceramic material, polymer material or the like which is subjected to a conductive treatment such a vapor deposition of metal to the surface thereof or the formation of a coating film in which the conductive powder is dispersed.

2. Intermediate Layer

Further, as exemplified in FIG. 2, the present invention is characterized in that the intermediate layer 12 which contains a binding resin and titanium oxide is formed on the support base body 13. Hereinafter, the intermediate layer is explained by separating the intermediate layer into the binding resin, the titanium oxide and the like.

(1) Binding Resin

As the binding resin, for example, it is preferable to use at least one resin selected from a group consisting of a polyamide resin, a polyvinyl alcohol resin, a polyvinyl butyral resin, a polyvinyl formal resin, a vinyl acetate resin, a phenoxy resin, a polyester resin, and an acrylic resin.

Here, when the polyamide resin is used, it may be preferable to use an alcohol-soluble polyamide resin in view of the excellent solubility thereof to a solvent. As a specific example, it maybe preferable to use a so-called copolymer nylon which are obtained by copolymerizing nylon 6, nylon 66, nylon 610, nylon 11, nylon 12 or the like, or a so-called denatured nylon which is obtained by chemically modifying nylon such as N-alkoxymethyl modified nylon, N-alkoxyethyl nylon or the like.

Further, when the polyvinyl butyral resin or the polyvinyl formal resin is used, it may be preferable to use a resin which contains 50 to 75 mol % of vinyl acetal, 10 to 50 mol % of polyvinyl alcohol and 0 to 15 mol % of polyvinyl acetate in the structure thereof.

The polyvinyl butyral resin can be obtained by allowing butylaldehyde to react with the polyvinyl alcohol resin, while the polyvinyl formal resin can be obtained by allowing formaldehyde to react with the polyvinyl alcohol resin. Since these resins exhibit the particularly excellent compatibility with a phenol resin and, at the same time, these resins exhibit the excellent reactivity and adhesiveness with the phenol resin, these resins are preferably used as the binding resins.

Further, it may be preferable to set the average molecular weight (number average molecular weight, this expression being used in the same manner hereinafter) of the binding resin to a value which falls within a range from 1,000 to 50,000.

The reason is that when the average molecular weight of the binding resin becomes less than 1,000, viscosity of the coating solution for forming the intermediate layer is remarkably lowered and hence, depending on the average molecular weight of the hole transferring agent to be added, there may arise a case in which a uniform film thickness is difficult to obtain and mechanical strength, film-forming property or adhesion property of the binding resin is remarkably lowered. On the other hand, when the average molecular weight of the binding resin exceeds 50,000, viscosity of the coating solution for forming the intermediate layer is remarkably increased and hence, there may arise a case in which it becomes difficult to control the thickness of the intermediate layer or charge mobility is remarkably lowered.

Accordingly, it maybe more preferable to set the average molecular weight of the binding resin to a value which falls within a range from 2,000 to 30,000 or it may be still more preferable to set the average molecular weight of the binding resin to a value which falls within a range from 5,000 to 15,000.

Here, the average molecular weight of the binding resin may be measured as the converted molecular weight expressed in terms of polystyrene by using gel permeation chromatography (GPC) or when the binding resin is a condensation resin, the average molecular weight of the binding resin may be obtained by calculation based on the degree of condensation of the binding resin.

Further, it may be preferable to set the solution viscosity (concentration of 5 weight % in a solution in which an ethanol/toluene ratio is set to 1:1) of the binding resin to a value which falls within a range from 10 to 200 mPa·sec.

The reason is that when the solution viscosity of the binding resin becomes less than 10 mPa·sec, there may arise a case in which the film-forming property of the intermediate layer is lowered and hence, the difference in film thickness of the intermediate layer becomes large, the mechanical strength or the adhering property of the intermediate layer is remarkably lowered and, further, dispersibility of the pigment and the like is remarkably lowered. On the other hand, when the solution viscosity of the binding resin exceeds 200 mPa·sec, there may arise a case in which it becomes difficult to form the intermediate layer having the uniform thickness.

Accordingly, it is more preferable to set the solution viscosity (concentration of 5 weight % in a solution in which an ethanol/toluene ratio is set to 1:1) of the binding resin to a value which falls within a range from 30 to 180 mPa·sec and it is still more preferable to set the solution viscosity of the binding resin to a value which falls within a range from 50 to 150 mPa·sec.

Further, when the binding resin is a film-forming resin containing a hydroxyl group, it is preferable to set the quantity of the hydroxyl group to a value which falls within a range from 10 to 40 mol %.

The reason is that when the quantity of the hydroxyl group of the binding resin including a hydroxyl group becomes less than 10 mol %, there may arise a case in which the mechanical strength, the film-forming property or the adhesion property of the intermediate layer is remarkably lowered or the dispersibility of the pigment or the like is also lowered. On the other hand, when the quantity of the hydroxyl group of the film-forming resin containing a hydroxyl group exceeds 40 mol %, there may arise a case in which the gelation of the binding resin is enhanced or it becomes difficult to form the intermediate layer having a uniform thickness.

Accordingly, when the film-forming resin containing a hydroxyl group is used as the binding resin, it is more preferable to set the quantity of the hydroxyl group of the binding resin to a value which falls within a range from 20 to 38 mol % or it is still more preferable to set the quantity of the hydroxyl group of the binding resin to a value which falls within a range from 25 to 35 mol %.

(2) Titanium Oxide

Further, the electrophotographic photoconductor is characterized by adding titanium oxide to the intermediate layer together with the above-mentioned binding resin.

The reason is that by adding titanium oxide having predetermined electric properties, it is possible to eliminate an extra charge in the photoconductor layer. Accordingly, with the addition of titanium oxide, it is possible to effectively prevent the generation of fogging under a high-temperature and high-moisture condition.

Further, the addition of titanium oxide can also enhance the mechanical strength and the adhesiveness of the intermediate layer together with the binding resin.

Still further, although titanium oxide possesses high light blocking property, by uniformly dispersing titanium oxide having a predetermined particle size in the intermediate layer, a predetermined transparency is obtained and hence, it is possible to measure a film thickness or the like of the intermediate layer by using an optical method.

Here, it is preferable to set the amount of titanium oxide which is contained in the intermediate layer to a value which falls within a range from 150 to 350 parts by weight with respect to 100 parts by weight of the binding resin.

The reason is that, due to such a constitution, the balance between the dispersibility of titanium oxide and the electrical insulating property of the intermediate layer is enhanced and hence, it is possible to further reduce the generation of fogging under a high-temperature and high-moisture condition.

Accordingly, due to the further enhancement of the balance between the dispersibility of titanium oxide and the electrical insulating property of the intermediate layer, it is more preferable to set the amount of titanium oxide which is contained in the intermediate layer to a value which falls within a range from 180 to 320 parts by weight with respect to 100 parts by weight of the binding resin and it is still more preferable to set the amount of titanium oxide which is contained in the intermediate layer to a value which falls within a range from 200 to 300 parts by weight with respect to 100 parts by weight of the binding resin.

Further, according to the electrophotographic photoconductor of the present invention, when the dispersibility of titanium oxide in the intermediate layer or the like is taken into consideration, it may be preferable to control the average secondary-particle size of titanium oxide. However, by controlling the average primary-particle size of titanium oxide, it is also possible to obtain excellent dispersibility of titanium oxide and, as a result, an L value of the intermediate layer can be adjusted to a value which falls within a predetermined range.

More particularly, it is preferable to control the average primary-particle size of titanium oxide to a value which falls within a range from 0.001 to 0.1 μm.

The reason is that by using the titanium oxide having such an average primary-particle size, the intermediate layer can obtain the predetermined transparency and it is also possible to measure a film thickness or the like of the intermediate layer by using an optical method. That is, titanium oxide having such an average primary-particle size can obtain the excellent dispersibility so as to be uniformly dispersed in the binding resin.

Accordingly, it is more preferable to set the average primary-particle size of titanium oxide which is contained in the intermediate layer to a value which falls within a range from 0.005 to 0.05 μm and it is still more preferable to set the average primary-particle size of titanium oxide which is contained in the intermediate layer to a value which falls within a range from 0.01 to 0.015 μm.

Here, the average primary-particle size or the average secondary-particle size of such titanium oxide can be calculated by combining an electron microscope photograph and an image processing apparatus.

Further, it may be preferable that the titanium oxide contained in the intermediate layer is covered with an organosilicone compound.

The reason is that, due to such a constitution, it is possible to control the water-absorbing property of titanium oxide and, at the same time, it is possible to further enhance the dispersibility of titanium oxide.

Here, it may be preferable to set a treatment quantity of organosilicone compound to a value which falls within a range from 1 to 50 parts by weight with respect to 100 parts by weight of titanium oxide contained in the intermediate layer.

The reason is that, when the treatment quantity of the organosilicone compound becomes less than 1 part by weight, there may arise a case that the treatment effect of the organosilicone compound can be hardly obtained and hence, the dispersibility is not enhanced. On the other hand, when the treatment quantity of the organosilicone compound exceeds 50 parts by weight, there may arise a case that it is difficult for titanium oxide to effectively exhibit the electric properties.

Accordingly, to further enhance the balance between the dispersibility or the like of the titanium oxide and the electric insulating property, it may be more preferable to set the treatment quantity of organosilicone compound to a value which falls within a range from 5 to 40 parts by weight with respect to 100 parts by weight of titanium oxide contained in the intermediate layer and it may be still more preferable to set the treatment quantity of organosilicone compound to a value which falls within a range from 10 to 30 parts by weight.

Here, as the organosilicone compound which is favorably used in the present invention, an alkylsilane compound, an alkoxysilane compound, a silane compound containing a vinyl group, a silane compound containing a mercapto group or a silane compound containing an amino group, or a polysiloxane compound which is a polycondensate of these compounds may be named.

As the more specific organosilicone compound, dimethylsiloxane, polydimethylsiloxane which is a condensate of dimethylsiloxane or the like may be preferably used.

(3) ΔL Value (in Accordance with JIS Z 8722)

Further, in constituting the electrophotographic photoconductor of the present invention, a value (ΔL value) which is obtained by subtracting an L value (a parameter value which is measured by a color-difference meter in accordance with JIS Z 8722) of the intermediate layer which is measured with respect to a single support base body from the L value which is measured in a state that the intermediate layer is formed on the above-mentioned support base body satisfies the following relationship formula (1).
−5.0≦ΔL≦0 (1)

The reason is that, by providing the intermediate layer having the ΔL value which falls within such a range, the dispersibility of titanium oxide in the intermediate layer is enhanced and hence, it is possible to reduce the generation of fogging under a high-temperature and high-moisture condition in the electrophotographic photoconductor.

Further, this is also because that, by keeping the dispersibility of titanium oxide in the intermediate layer in a preferable state, it is possible to enhance the preservation stability of the coating solution for forming a intermediate layer or the like. Accordingly, it is possible to easily and stably manufacture not only the intermediate layer but also the photoconductor layer thus realizing the economical acquisition of the electrophotographic photoconductor which possesses the stable electric properties.

Here, with respect to the optical property of the intermediate layer, it is confirmed that when either one of the above-mentioned ΔL value and ΔA value described later is set to a value which falls within a predetermined range, the dispersibility of titanium oxide in the intermediate layer assumes a preferable state. Further, when the ΔL value satisfies the relationship formula (1) and the ΔA value satisfies the relationship formula (2), it is possible to further enhance the dispersibility of titanium oxide.

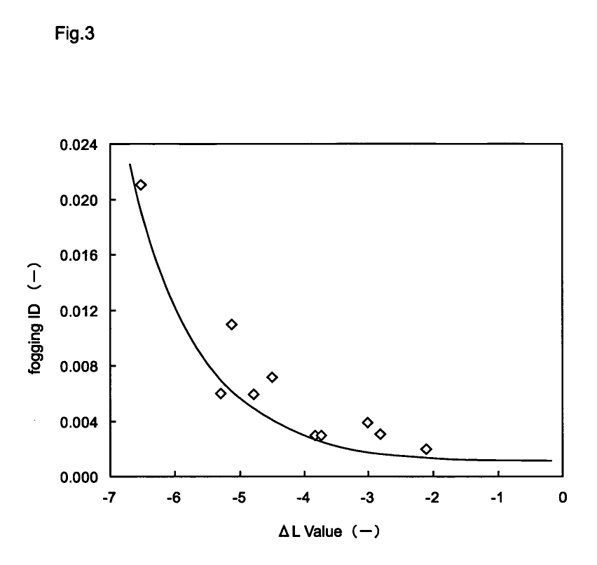

Here, the relationship between the ΔL value of the intermediate layer and fogging ID when an image is formed by using a photoconductor including such an intermediate layer is explained. That is, in conjunction with FIG. 3, the relationship between the ΔL value (−) of the intermediate layer and the fogging ID (−) is specifically explained.

FIG. 3 shows a characteristic curve when the fogging ID (−) of a formed image is taken on an axis of ordinates and the ΔL value (−)of the intermediate layer which constitutes the photoconductor is taken on an axis of abscissas.

It is understood from the characteristic curve that, when the ΔL value of the intermediate layer approaches 0 from −7.0, the fogging ID value is decreased. Accordingly, it is understood that it is effective to keep the ΔL value of the intermediate layer to a relatively large value to restrict the fogging ID value to a small value.

More specifically, by setting the ΔL value of the intermediate layer to a value which falls within a range from −5.0 to 0, it is possible to make the fogging ID value assume a value of 0.008 or less. Accordingly, it is more preferable to set the ΔL value to a value which falls within a range from −4.0 to 0, and it is still more preferable to set the ΔL value to a value which falls within a range from −3.0 to 0.

Here, since a method for measuring the ΔL value of the intermediate layer and a method for measuring the fogging ID are explained in detail in conjunction with examples described later, their explanations are omitted here.

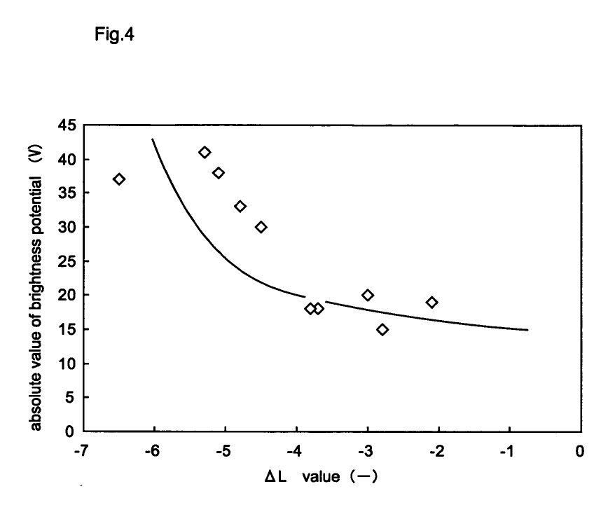

Further, the relationship between the ΔL value of the intermediate layer and the brightness potential of the photoconductor which includes such an intermediate layer is explained. That is, in conjunction with FIG. 4, the relationship between the ΔL value (−) of the intermediate layer and the brightness potential (V) is specifically explained.

FIG. 4 shows a characteristic curve when the absolute value of the brightness potential (V) of a formed image is taken on an axis of ordinates and the ΔL value (−) of the intermediate layer which constitutes the photoconductor is taken on an axis of abscissas.

It is understood from the characteristic curve that, when the ΔL value of the intermediate layer approaches 0 from −7.0, the absolute value of the brightness potential (V) is decreased. Accordingly, it is effective to keep the ΔL value of the intermediate layer to a relatively large value to restrict the absolute value of the brightness potential (V) to a small value.

To be more specific, by setting the ΔL value of the intermediate layer to a value which falls within a range from −5.0 to 0, it is possible to allow the absolute value of the brightness potential (V) to assume approximately 30 (V) or less. Accordingly, it is more preferable to set the ΔL value to a value which falls within a range from −4.0 to 0, and it is still more preferable to set the ΔL value to a value which falls within a range from −3.0 to 0.

Since the method for measuring the brightness potential (V) is explained in detail in conjunction with the examples described later, the explanation is omitted here.

(4) Δa Value (in Accordance with JIS Z 8722)

Further, in constituting the electrophotographic photoconductor of the present invention, it may be preferable to set a value (Δa value) which is obtained by subtracting a a value (a parameter value which is measured by a color-difference meter in accordance with JIS Z 8722) of the intermediate layer which is measured with respect to a single support base body from the a value which is measured in a state that the intermediate layer is formed on the support base body to a value which falls within a range from −1.2 to 0.

The reason is that, by taking the Δa value which falls within such a range into consideration, the number of kinds of parameters which can be measured by a color-difference meter is increased and hence, the dispersibility of titanium oxide can be determined more accurately. As a result, the balance between the dispersibility of titanium oxide and the electric insulating property of the intermediate layer is further enhanced thus further reducing the generation of fogging under a high-temperature and high-moisture condition. Accordingly, it is more preferable to set the Δa value to a value which falls within a range from −0.8 to −0.2, and it is still more preferable to set the Δa value to a value which falls within a range from −0.6 to −0.3.

(5) Δb Value (in Accordance with JIS Z 8722)

Further, in constituting the electrophotographic photoconductor of the present invention, it may be preferable to set a value (Δb value) which is obtained by subtracting a a value (a parameter value which is measured by a color-difference meter in accordance with JIS Z 8722) of the intermediate layer which is measured with respect to a single support base body from the a value which is measured in a state that the intermediate layer is formed on the support base body to a value which falls within a range from 0 to 10.

The reason is that, by taking the Δb value which falls within such a range into consideration, the number of kinds of parameters which can be measured by the color-difference meter is increased and hence, the dispersibility of titanium oxide can be determined more accurately. As a result, the balance between the dispersibility of titanium oxide and the electric insulating property of the intermediate layer is further enhanced thus further reducing the generation of fogging under a high-temperature and high-moisture condition. Accordingly, it is more preferable to set the Δb value to a value which falls within a range from 1 to 6 and it is still more preferable to set the Δb value to a value which falls within a range from 2 to 4.

(6) Reflection Absorbance (ΔA Value)

Further, in constituting the electrophotographic photoconductor of the present invention, a value (ΔA value) which is obtained by subtracting the reflection absorbance of the intermediate layer (a parameter value which is measured by a color-difference meter) which is measured with respect to the single support base body from the reflection absorbance of the intermediate layer which is measured in a state that the intermediate layer (reference thickness: 2 μm) is formed on the support base body may satisfy a following relationship formula (2).
ΔA≦0.055 (2)

The reason is that, it is confirmed that by setting the reflection absorbance of the intermediate layer (ΔA value) having a predetermined thickness to a value equal to or less than 0.055, the dispersion state of titanium oxide in the intermediate layer assumes a preferable state.

That is, along with the increase of the non-uniformity of a dispersion state of titanium oxide which remains in the intermediate layer, a quantity of white aggregated particles which remains in the intermediate layer is increased and hence, scattering of light when the light is radiated to the intermediate layer is increased. Accordingly, the reflection absorbance of the intermediate layer (ΔA value) assumes a larger value. On the other hand, when the uniformity of dispersion state of the titanium oxide in the intermediate layer is increased, the white aggregated particles do not remain and scattering of light is decreased when the interlayer is radiated. Accordingly, the reflection absorbance of the intermediate layer (ΔA value) assumes a small value.

Accordingly, provided that the reflection absorbance of the intermediate layer (ΔA value) assumes a value equal to or less than 0.055, when a content of titanium oxide or the like is set to a value which falls within a predetermined value, it is possible to determine that the dispersion state of titanium oxide in the intermediate layer assumes a preferable state. With the use of such an intermediate layer, the electric properties of the photoconductor are enhanced and hence, it is possible to prevent fogging under a high-temperature and high-moisture condition. Further, the preservation stability of the coating solution for forming a intermediate layer for forming such an intermediate layer is also enhanced and hence, it is possible not only to facilitate the manufacturing of the intermediate layer but also to easily and stably manufacture the photoconductor layer.

However, when the content of titanium oxide or the like contained in the intermediate layer is decreased and the reflection absorbance of the intermediate layer (ΔA value) becomes excessively small, there may arise a case that it is difficult to allow the charge remaining in the photoconductor to effectively escape into the conductive base body. Accordingly, it is preferable to set a lower limit of the reflection absorbance of the intermediate layer (ΔA value) to a value equal to or more than 0.005.

Accordingly, it is more preferable to set the lower limit of the reflection absorbance of the intermediate layer (ΔA value) to a value which falls within a range from 0.008 to 0.05 and it is still more preferable to set the lower limit of the reflection absorbance of the intermediate layer (ΔA value) to a value which falls within a range from 0.01 to 0.045.

Here, when a thickness of the intermediate layer is changed, the value of reflection absorbance may be adjusted by considering the reference thickness. For example, when the thickness of the intermediate layer is 4 μm, the value of obtained reflection absorbance may be set to ½ of the reference absorbance when the thickness is the reference thickness.

Further, with respect to the optical property of the intermediate layer, provided that both of the above-mentioned ΔL value and ΔA value or either one of the above-mentioned ΔL value and ΔA value assumes a value which falls within a predetermined range, it is confirmed that the dispersibility of titanium oxide in the intermediate layer is in a preferable state. However, although this may be partially repetitious, when the ΔL value satisfies the relationship formula (1) and the ΔA value satisfies the relationship formula (2), it is possible to further enhance the dispersibility of titanium oxide.

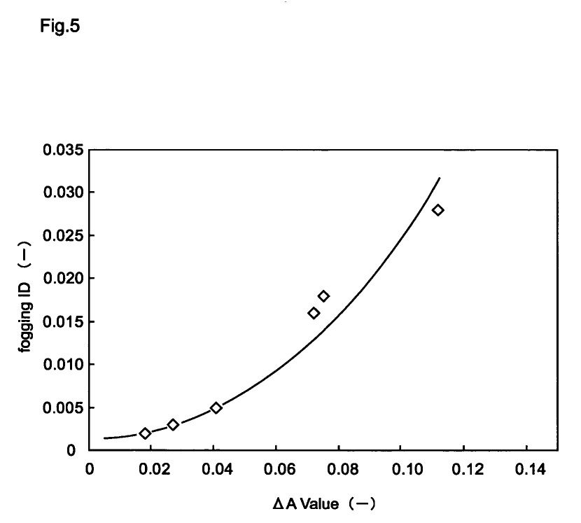

Here, the relationship between the reflection absorbance of the intermediate layer (ΔA value) and the fogging ID when an image is formed by using a photoconductor which includes such an intermediate layer is explained. That is, in conjunction with FIG. 5, the relationship between the reflection absorbance (ΔA value) (−) of the intermediate layer and the fogging ID (−) is specifically explained.

FIG. 5 shows a characteristic curve when the fogging ID (−) of a formed image is taken on an axis of ordinates and the reflection absorbance (ΔA value) (−) of the intermediate layer which constitutes the photoconductor is taken on an axis of abscissas.

As understood from the characteristic curve, along with the increase of the ΔA value of the intermediate layer, the fogging ID value is also increased. Accordingly, it is understood that it is effective to keep the ΔA value of the intermediate layer to a small value to hold the fogging ID value at a low level. To be more specific, by setting the ΔA value of the intermediate layer to a value equal to or less than 0.055, it is possible to allow the fogging ID value to assume a value less than 0.008.

Here, a method for measuring the ΔA value of the intermediate layer and the method for measuring the fogging ID are explained in detail in conjunction with the examples described later, their explanations are omitted here.

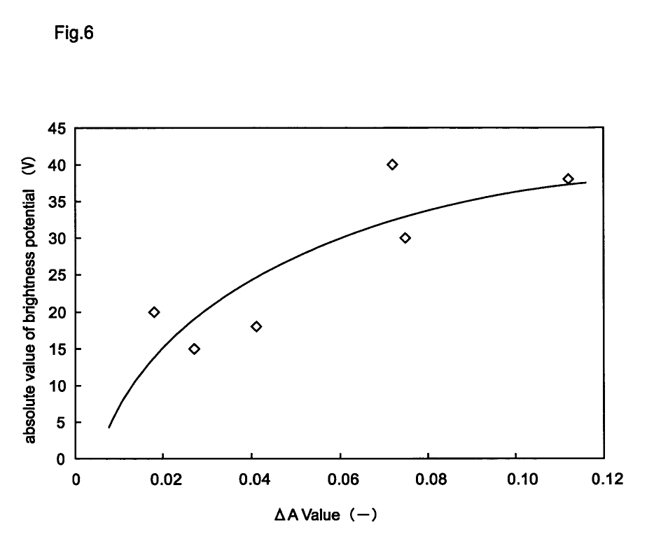

Further, the relationship between the above-mentioned reflection absorbance of the intermediate layer (ΔA value) and the electric properties of the photoconductor which includes such an intermediate layer is explained. That is, in conjunction with FIG. 6, the relationship between the ΔA value (−) of the intermediate layer and the brightness potential (V) is specifically explained.

FIG. 6 shows a characteristic curve when the absolute value of the brightness potential of the photoconductor is taken on an axis of ordinates and the ΔA value (−) of the intermediate layer which constitutes the photoconductor is taken on an axis of abscissas.

As understood from the characteristic curve, along with the increase of the ΔA value of the intermediate layer, the absolute value of the brightness potential is also increased. Accordingly, it is understood that it is effective to keep the ΔA value of the intermediate layer to a small value to hold the absolute value of the brightness potential at a low level and to hold the sensibility of the photoconductor at a high level. To be more specific, by setting the ΔA value of the intermediate layer to a value equal to or less than 0.055, it is possible to allow the absolute value of the brightness potential of the photoconductor to assume a value less than approximately 30V.

Here, the method for measuring the ΔA value of the intermediate layer and the method for measuring the brightness potential of the photoconductor are explained in detail in conjunction with the example described later and hence, their explanations are omitted here.

(7) Additive

Further, in the intermediate layer, to prevent the generation of interference fringes by generating scattering of light, to enhance the dispersibility or to achieve other purpose, it is preferable to add various kinds of additives (organic fine powder or inorganic fine powder) which are different from an electron transferring pigment.

Particularly, a white pigment made of zinc oxide, zinc white, zinc sulfide, lead white, lithopone or the like, an inorganic pigment as an extender pigment made of alumina, calcium carbonate and barium sulfate and the like, fluororesin particles, benzoguanamine resin particles, styrene resin particles and the like are the preferable additives.

Further, when the additive such as the fine powder is added, it may be preferable to set a particle size of the fine powder to a value which falls within a range from 0.01 to 3 μm. The reason is that when the particle size is excessively large, the unevenness of the intermediate layer may be increased, electrically non-uniform patterns maybe formed or, a defective image quality may be liable to be easily generated. On the other hand, when the particle size is excessively small, a sufficient light scattering effect may not be obtained.

When the additive such as the fine powder is added, it may be preferable to set an amount of the additive to a value which falls within a range from 1 to 70 weight % and, more preferably, to a value which falls within a range from 5 to 60 weight % in a weight ratio with respect to a solid content of the intermediate layer.

Further, it may be also preferable to add a hole transferring agent to the intermediate layer. That is, by allowing the intermediate layer to contain the hole transferring agent, electrons which are generated in a charge generating layer can be readily moved to a base body side thus preventing the elevation of a residual potential attributed to the storing of the electrons being stored in the intermediate layer and hence, the intermediate layer can exhibit stable electrical properties.

As such a hole transferring agent, various kinds of conventional compounds may be used. To be more specific, a benzidine compound, a phenylenediamine compound, a naphthylenediamine compound, a phenanthrylenediamine compound, an oxadiazole compound, a styryl compound, a carbozole compound, a pyrazoline compound, a hydrazone compound, a triphenylamine compound, an indole compound, an oxazole compound, an isoxazole compound, a thiazole compound, a thiadiazole compound, an imidazole compound, a pyrazole compound, a triazole compound, a butadiene compound, a pyrene hydrazone compound, an acrolein compound, a carbazole-hydrazone compound, a quinoline-hydrazone compound, a stylbene compound, a stylbene-hydrazone compound, and a diphenylenediamine compound may be used in a single form or in combination of two or more kinds of compounds.

(8) Film Thickness

Further, the increase of a film thickness of the intermediate layer enhances property to conceal surface irregularities of the support base body and hence, the increase of the film thickness is preferable in decreasing spot-like image quality defect. On the other hand, the increase of the film thickness is apt to lower the electric properties such as the elevation of residual potential.

Accordingly, it may be preferable to set the film thickness of the intermediate layer to a value which falls within a range from 0.1 to 50 μm, and it may be more preferable to set the film thickness of the intermediate layer to a value which falls within a range from 1 to 30 μm.

3. Photoconductor Layer

(1) Charge Generating Layer

It may be preferable to form the charge generating layer by depositing a charge generating agent by using a vacuum vapor deposition method or by dispersing the charge generating agent in the intermediate layer together with an organic agent or a binding resin for coating.

As such a charge generating agent, inorganic photoconductive materials such as amorphous selenium, crystalline selenium, selenium-tellurium alloy, selenium-arsenic alloy, other selenium compounds or selenium alloys, zinc oxide, titanium oxide, various kinds of phthalocyanine pigments such as non-metal phthalocyanine, titanylphthalocyanine, copper phthalocyanine, tin phthalocyanine, gallium phthalocyanine, chloro indium phthalocyanine, a sruarylium group, a polycyclic aromatic compound group, an azo group pyrylium salt, thiapyrylium salt and the like may be used in a single form or in combination of two or more of these materials.

Further, these organic pigments generally have several kinds of crystal types, wherein particularly the phthalocyanine pigment is known as the pigment which has kinds of crystal types such as α, β and the like. However, any crystal type is applicable so long as the pigment can obtain sensitivity suitable for the purpose of the pigment.

Further, as a binding resin which is used for forming the charge generating layer, a polycarbonate resin such as bisphenol A type, bisphenol Z type, bisphenol C type and the like, a polyester resin, a methacrylic resin, an acrylic resin, a polyvinylchloride resin, a polystyrene resin, a polyvinyl acetate resin, a styrene-butadiene copolymer resin, a vinylidinechloride-acrylonitrile copolymer resin, a vinyl chroride—vinyl acetate—maleic anhydride resin, a silicone resin, a silicone-alkyd resin, a phenol-formaldehyde resin, a styrene-alkyd resin, an N-vinylcarbozole may be used in a single form or in combination of two or more kinds of these materials.

Further, in adding these binding resins, it may be preferable to set a blending ratio (weight ratio) between the charge generating agent and the binding resin to a value which falls within a range from 10:1 to 1:10.

Further, it may be preferable to set a film thickness of the charge generating layer to a value which falls within a range from 0.01 to 5 μm generally, and it may be more preferable to set a film thickness of the charge generating layer to a value which falls within a range from 0.05 to 2.0 μm preferably.

Further, as a method for dispersing the charge generating agent in the binding resin, the method such as a roll mill, a ball mill, a vibration ball mill, an Atliter, a DYNO-MILL, a sand mill or a colloid mill may be used.

(2) Charge Transfer Layer

Further, as a charge transfer agent which is used for a charge transfer layer (a hole transferring agent and an electron transfer agent), an oxadiazole derivative such as 2,5-bis(p-diethylaminophenyl)-1,3,4-oxadiazole, a pyrazoline derivative such as 1,3,5-triphenyl-pyrazoline, 1-[pyridyl-(2)]-3-(p-diethylaminostyryl)-5-(p-diethylaminostyryl) pyrazoline, an aromatic tertiary amino compound such as triphenylamine, tri(p-methyl)phenylamine, N,N-bis(3,4-dimethylphenyl)biphenyl-4-amine, dibenzylaniline, an aromatic tertiary diamino compound such as N,N′-diphenyl-N,N′-bis(3-methylphenyl)-[1,1-biphenyl]-4,4′-diamine, a 1,2,4-triazine derivative such as 3-(4′-dimethyl aminophenyl)-5,6-di-(4′-methoxyphenyl)-1,2,4-triazine, a hydrazone derivative such as 4-diethylamino benzaldehyde-1,1-diphenyl hydrazone, a quinazoline derivative such as 2-phenyl-4-styryl quinazoline, a benzofuran derivative such as 6-hydroxy-2,3-di(p-methoxyphenyl)-benzofuran, an α-stilbene derivative such as p-(2,2-diphenylvinyl)-N,N-diphenylaniline, an enamine derivative, a carbazole derivative such as, N-ethylcarbazole, a hole transfer agent such as poly-N-vinylcarbazole and a derivative thereof, chloranil, bromoanil, a quinine compound such as anthrquinone, tetracyano quinodimethane compound, a fluorenone compound such as 2,4,7-trinitrofluorenone, 2,4,5,7-tetranitro-9-fluorenone, xanthone compound, thiophene compound, an electron transfer agent such as diphenoquinone compound; and a polymer or the like having, as a group consisting of the above-mentioned compounds, a main chain or a side chain thereof may be used in a single form or in combination of two or more kinds of these materials.

Further, as a binding resin which is used for the charge transfer layer, in particular, a polycarbonate resin such as an acrylic resin, polyarylate, a polyester resin, bisphenol A type, bisphenol Z type, bisphenol C type and the like, an insulating resin such as polystyrene, acrylonitrile-styrene copolymer, acrylonitrile-butadiene copolymer, polyvinyl butyral, polyvinyl formal, polysulfone, polyacrylamide, polyamide, chlororubber or an organic photoconductive polymer such as polyvinyl carbozole, polyvinyl anthracene, polyvinyl pyrene and a copolymer resin thereof may be used.

Further, the charge transfer layer maybe formed such that a solution in which the electron transfer agent and the binding resin are dissolved in an appropriate solvent is applied and is dried thereafter.

As a solvent which is used in forming the charge transfer layer in this manner, for example, aromatic hydrocarbon such as benzene, toluene, chlorobenzen, ketons such as acetone, 2-butanone, a halogenated aliphatic hydrocarbon groups such as methylene chloride, chloroform, chloroethylene, cyclic ether or linear ether such as tetrahydrofuran, dioxane, ethylene glycol, diethyl ether, or a mixed solvent thereof may be used.

Further, it may be preferable to set the blending ratio between the electron transfer agent and the binding resin to a value which falls within a range from 10:1 to 1:5. Further, it may be preferable to generally set a film thickness of the charge transfer layer to a value which falls within a range from 5 to 50 μm, and it maybe more preferable to set the film thickness to a value which falls within a range from 10 to 40 μm.

Still further, to prevent the deterioration of the photoconductor caused by ozone, an oxidative gas, light or heat which is generated in an electrophotographic device, it may be preferable to add an oxidation inhibitor, a light stabilizer, a heat stabilizer and the like to the photoconductor layer.

For example, as the oxidation inhibitor, hindered phenol, hindered amine, para-phenylenediamine, arylalkane, hydroquinone, spirochroman, spiroindanone or a derivative thereof, an organic sulfur compound, an organophosporous compound or the like are may be used. Further, as the light stabilizer, a derivative of benzophenone, benzotriazole, dithiocarbamate, tetramethylpiperidin or the like may be used.

4. Single-layer Type Electrophotographic Photoconductor

Further, in constituting the electrophotographic photoconductor of the present invention, the photoconductor may also preferably be a single-layer type electrophotographic photoconductor 10 which includes a support base body 13, an intermediate layer 12 and a photoconductor layer 11 as exemplified in FIG. 1(a).

As shown in FIG. 1(b), it may be also preferable to provide a protective layer 11′ on a photoconductor layer 11.

Further, the single-layer type electrophotographic photoconductor may also include an intermediate layer in the same manner as the multi-layer type electrophotographic photoconductor. On the other hand, the photoconductor layer which is formed on the intermediate layer may be formed such that a photoconductor layer coating solution is formed by dispersing and mixing a charge generating agent, a charge transferring agent, a binding resin and the like similar to corresponding material of the multi-layer type electrophotographic photoconductor together with a dispersion medium. And, thereafter, the coating solution applied to the intermediate layer and is dried.

Further, it may be preferable to set a content of a charge generating agent in the single-layer type photoconductor layer to a value which falls within a range from 0.1 to 50 parts by weight with respect to 100 parts by weight of the binding resin and it may be more preferable to set the content of the charge generating agent to a value which falls within a range from 0.5 to 30 parts by weight with respect to 100 parts by weight of the binding resin.

Further, it may be preferable to set a content of a hole transferring agent to a value which falls within a range from 1 to 120 parts by weight with respect to 100 parts by weight of the binding resin and it may be more preferable to set the content of the hole transferring agent to a value which falls within a range from 5 to 100 parts by weight with respect to 100 parts by weight of the binding resin.

Further, in the same manner as the hole transferring agent, it may be also preferable to set a content of an electron transfer agent to a value which falls within a range from 1 to 120 parts by weight with respect to 100 parts by weight of the binding resin and it may be more preferable to set the content of the electron transfer agent to a value which falls within a range from 5 to 100 parts by weight with respect to 100 parts by weight of the binding resin.

Further, it may be preferable to set a thickness of the photoconductor layer to a value which falls within a range from 5.0 to 100 μm and it may be more preferable to set the thickness of the photoconductor layer to a value which falls within a range from 10 to 80 μm.

5. Image Forming Apparatus

(1) Basic Constitution

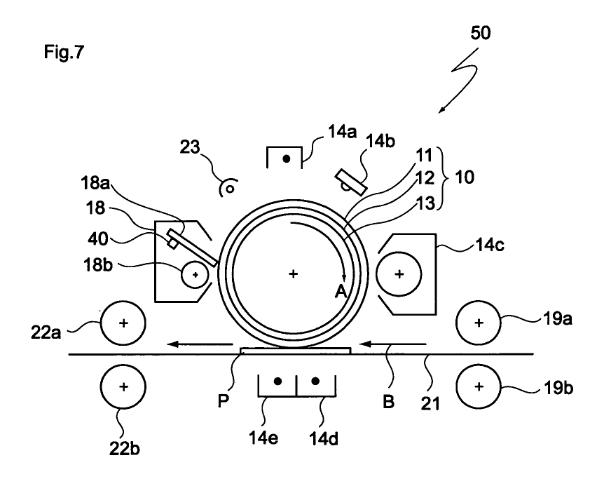

Next, the basic constitution of an image forming apparatus 50 according to the present invention is shown in FIG. 7. The image forming apparatus 50 includes a drum type photoconductor 10 and, in the periphery of this photoconductor 10, along the rotational direction indicated by an arrow A, a primary charger 14a, an exposure device 14b, a developing unit 14c, a transfer charger 14d, a separation charger 14e, a cleaning device 18 and a charge eliminator 23 are sequentially mounted.

Further, a recording paper “P” is transferred along the conveying direction indicated by an arrow B in order from the upstream side by using paper feeding rollers 19a, 19b and a conveying belt 21. In the midst of the conveying belt 21, a fixing roller 22a and a pressing roller 22b for forming an image by fixing toner are arranged.

Here, the photoconductor 10 forms the above-mentioned predetermined intermediate layer 12 on the support base body 13. Accordingly, the intermediate layer has a uniform thickness and, at the same time, the intermediate layer may exhibit the excellent electric properties and image properties for a long period.

(2) Manner of Operation

Next, the basic manner of operation of the image forming apparatus 50 is explained in conjunction with FIG. 7.

First of all, the photoconductor 10 of the image forming apparatus 50 is rotated at a predetermined processing speed (peripheral speed) in the direction indicated by an arrow A by using a drive means (not shown in the drawing) and, at the same time, a surface of the photoconductor is charged with a predetermined polarity and potential by the primary charger 14a. For example, when a method which brings a conductive resilient roller into contact with a surface of the photoconductor is adopted, it may be preferable to apply a DC voltage of approximately 1 to 2KV to the surface of the photoconductor thus positively charging the surface to 50 to 2000V.

Next, by using the exposure device 14b such as a laser, an LED or the like, light is radiated to the surface of the photoconductor by way of a reflection mirror and the like while being optically modulated in response to image data thus exposes the surface of the photoconductor 10. Due to this exposure, a latent image is formed on the surface of the photoconductor 10.

Next, based on the latent image, a developer (toner) is developed by the developing unit 14c. That is, the toner is stored in the developing unit 14c and, by applying a predetermined developing bias to a developing sleeve which the developing unit 14c includes, the toner is adhered to the photoconductor 10 corresponding to the latent image on the photoconductor 10 thus forming a toner image.

Next, the toner image formed on the photoconductor 10 is transferred to the recording paper “P”. This recording paper “P” is fed from a paper feeding cassette (not shown in the drawing) by the paper feeding rollers 19a, 19b and, thereafter, the recording paper “P” is adjusted to be synchronized with the toner image on the photoconductor 10 in timing thus supplying the recording paper “P” to a transfer part arranged between the photoconductor 10 and the transfer charger 14d. Then, by applying a predetermined transfer bias to the transfer charger 14d, the toner image on the photoconductor 10 can be surely transferred to the recording paper “P”.

Next, the recording paper “P” to which the toner image is transferred is separated from a surface of the photoconductor 10 by the separate charger 14e and is carried to a fixing unit by the conveying belt 21. Here, the recording paper “P” receives heat treatment and pressing treatment by the fixing roller 22a and the pressing roller 22b and hence, the toner image is fixed to the surface of the recording paper “P” and, thereafter, the recording paper “P” is discharged to the outside of the image forming apparatus 50 by a discharge roller (not shown in the drawing).

On the other hand, after the toner image is transferred from the photoconductor 10, the photoconductor 10 continues the rotation thereof and the residual toner (adhesive material) which is not transferred to the recording paper “P” at the time of transferring is removed from the surface of the photoconductor 11 by a cleaning device 18 and, at the same time, the photoconductor 10 is used in the next image forming.

Here, as described previously, the photoconductor 10 forms the predetermined intermediate layer 12 on the support base body 13 and hence, the photoconductor 10 can exhibit the excellent electric properties and the image properties for a long period.

[Second Embodiment]

A second embodiment of the present invention provides a manufacturing method of an electrophotographic photoconductor which includes a support base body, an intermediate layer and a photoconductor layer, wherein the manufacturing method of the electrophotographic photoconductor includes a step for manufacturing a coating solution for forming the intermediate layer by dispersing titanium oxide in a binding resin solution containing a binding resin and an organic solvent, and a step for forming the intermediate layer in which a ΔL value of the intermediate layer satisfies a following relationship formula (1) or a ΔA value of the intermediate layer satisfies a following relationship formula (2) by using the coating solution for forming a intermediate layer for forming the intermediate layer.
−5.0≦ΔL≦0 (1)
ΔA≦0.055 (2)

ΔL value: a value which is obtained by subtracting an L value (a parameter value which is measured by a color-difference meter in accordance with JIS Z 8722) which is measured with respect to a single support base body from the L value which is measured in a state that the intermediate layer is formed on the support base body.

ΔA value: a value which is obtained by subtracting reflection absorbance (a parameter value which is measured by a color-difference meter) which is measured with respect to a single support base body from the reflection absorbance which is measured in a state that the intermediate layer is formed on the support base body.

Hereinafter, the explanation of the second embodiment is specifically made by focusing on a point which differs from the explanation of the first embodiment.

1. Preparation of Support Base Body

To prevent the generation of the interference pattern, it may be preferable to perform the rough surface treatment on the surface of the support base body by using etching, anodic oxidization, a wet blasting method, a sand blasting method, rough cutting, centerless cutting or the like.

2. Formation of Intermediate Layer

(1) Preparation of a Coating Solution for Forming Intermediate Layer

Further, in forming the intermediate layer, it is preferable to add a hole transferring agent or the like to a solution in which a resin component is dissolved and, thereafter, to perform dispersing treatment of the hole transferring agent or the like so as to form the coating solution.

Further, although the method of performing the dispersing treatment is not particularly limited, it may be preferable to use a generally-known method such as a roll mill, a ball mill, a vibration ball mill, an Atliter, a sand mill, a colloid mill, a paint shaker or the like.

Further, in manufacturing the coating solution for forming a intermediate layer, the binding resin may preferably be solved in the coating solution in plural stages and, at the same time, the binding resin may preferably be mixed with titanium oxide.

To be more specific, the manufacturing of the coating solution for a intermediate layer may preferably include following steps (A) and (B).
(A) A step in which titanium oxide is added to a binding resin solution in which 31 to 65 weight % of the binding resin with respect to a total quantity of binding resin which constitutes the intermediate layer is dissolved thus forming a primary dispersion liquid.
(B) A step in which 35 to 69 weight % of the binding resin with respect to the total quantity of binding resin is dissolved in the primary dispersing solution thus preparing the coating solution for a intermediate layer.

The reason is that, when the total quantity of the binding resin, the total quantity of titanium oxide and the organic solvent are mixed in one step without dividing the step into the plurality of steps, a contact ratio of surfaces of titanium oxide with the resin and a contact ratio of the surfaces of the titanium oxide with the organic solvent are liable to easily become non-uniform. Accordingly, there may arise a case that the characteristics of the surface of titanium oxide in the coating solution for a intermediate layer must be changed and hence, the dispersibility of titanium oxide maybe deteriorated. When the mixing is performed in one step, especially, when the titanium oxide having an average primary particle size is equal to or less than 0.015 μm, there may be a case that the dispersibility of titanium oxide is remarkably reduced.

On the other hand, when two steps (A), (B) are provided in the manufacture of the coating solution for a intermediate layer, first of all, in the step (A), the concentration of titanium oxide in the primary dispersing liquid is extremely elevated and hence, it is possible to easily make the contact ratios of the surfaces of individual titanium oxide particles with the resin and the contact ratios of the surfaces of the individual titanium oxide particles with the organic solvent uniform. Accordingly, in the subsequent step (B), even when the total quantity of binding resin is added to the coating solution, the dispersibility of titanium oxide is kept in a fixed state. As a result, the preservation stability of the coating solution for a intermediate layer is enhanced and hence, it is possible to easily and stably form the predetermined intermediate layer. Further, by using the coating solution for forming a intermediate layer, it is possible to efficiently manufacture the electrophotographic photoconductor which generates only small fogging under a high-temperature and high-moisture condition.

Accordingly, it may be preferable to set the quantity of the binding resin which is added in step (A) to an amount corresponding to 35 to 60 weight % of the total quantity of the binding resin. It is still more preferable to set the quantity of the binding resin which is added in step (A) to an amount corresponding to 40 to 55 weight % of the total quantity of the binding resin.

(2) Coating Method of Coating Solution for Forming a Intermediate Layer

Further, although the coating method for applying the coating solution for forming a intermediate layer is not particularly limited, coating methods such as an immersion coating method, a spray coating method, a bead coating method, a blade coating method, a roller coating method and the like may be used.

Here, to form the intermediate layer and the photoconductor layer on the intermediate layer in a more stable manner, it may be preferable to perform a heating/drying processing for 5 minutes to 2 hours at a temperature of 30 to 200° C. after the coating solution for forming a intermediate layer is applied.

3. Formation of Photoconductor

Further, after the photoconductor-layer-forming coating solution is prepared, it may be preferable to form the photoconductor layer by using the immersion coating method, the spray coating method, the bead coating method, the blade coating method, the roller coating method or the like. Here, when the moisture adding treatment method is not used, it may be preferable to dry the photoconductor using heat after the photoconductor is dried to the touch at a room temperature. Then, as a condition of heating/drying, it may be preferable to dry the photoconductor at a temperature which falls within a range from 30 to 200° C. and for a period which falls within a range from 5 minutes to 2 hours.

### EXAMPLES

Hereinafter, the present invention is specifically explained in conjunction with examples. However, the present invention is not limited to contents described in these examples.

1. Formation of Coating Solution A for Forming a Intermediate Layer

150 parts by weight of titanium oxide (made by Teika Seiyaku KK, SMT-02, number average primary particle size: 10 nm) to which surface treatment is applied with alumina and silica, and, thereafter, surface treatment is applied with methylhydrogenpolysiloxane, 100 parts by weight of titanium oxide (made by Teika Seiyaku KK, MT-05, number average primary particle size: 10 nm) to which surface treatment is applied with alumina and silica, 600 parts by weight of methanol, 150 parts by weight of butanol, and 50 parts by weight of Amilan CM8000 (made by TORAY, IND. INC, quatercopolymer polyamide resin) which is preliminarily dissolved in 200 parts by weight of methanol and 50 parts by weight of butanol are filled in a container and, thereafter, are mixed for 1 hour by using a bead mill (media: zirconia balls having a diameter of 0.5 mm) thus producing a primary dispersion solution.

Subsequently, 50 parts by weight of Amilan CM8000 which is preliminarily dissolved in 200 parts by weight of methanol and 50 parts by weight of butanol is added to the primary dispersion solution and, thereafter, are mixed for 1 hour by using a paint shaker to perform a secondary dispersion thus producing the coating solution A for forming a intermediate layer.

Here, with respect to the amounts of the respective constituent materials in the above-mentioned coating solution for forming a intermediate layer, a total quantity of Amilan CM8000 which is added to the coating solution for forming a intermediate layer is set as a reference quantity (100 parts by weight). This applies in the same manner to coating solution for forming a intermediate layers which are described hereinafter.

2. Formation of Coating Solution B for Forming a Intermediate Layer

The coating solution B for forming a intermediate layer is formed in the same manner as the coating solution A for forming a intermediate layer except that the primary dispersion by using the bead mill is performed for 2 hours and the secondary dispersion by using the paint shaker is performed for 2 hours.

3. Formation of Coating Solution C for Forming a Intermediate Layer

The coating solution C for forming a intermediate layer is formed in the same manner as the coating solution A for forming a intermediate layer except that the secondary dispersion by using the paint shaker is performed for 0.5 hours.

4. Formation of Coating Solution D for Forming a Intermediate Layer

The coating solution D for forming a intermediate layer is formed in the same manner as the coating solution A for forming a intermediate layer except that the primary dispersion by using the bead mill is performed for 0.5 hours.

5. Formation of Coating Solution E for Forming a Intermediate Layer

The coating solution E for forming a intermediate layer is formed in the same manner as the coating solution A for forming a intermediate layer except that the primary dispersion by using the bead mill is performed for 0.5 hours and the secondary dispersion by using the paint shaker is performed for 0.5 hours.

6. Formation of Coating Solution F for Forming a Intermediate Layer

The coating solution F for forming a intermediate layer is formed in the same manner as the coating solution A for forming a intermediate layer except for the following steps. That is, as titanium oxide to which surface treatment is applied with alumina and silica and, thereafter, surface treatment is applied with methylhydrogenpolysiloxane, SMT-500SAS (number average primary particle size: 35 nm) is used instead of SMT-02 (number average primary particle size: 10 nm) made by TEIKA. As titanium oxide to which surface treatment is applied only with alumina and silica, MT-600BS (number average primary particle size: 35 nm) is used instead of MT-05 (number average primary particle size: 10 nm) made by TEIKA. Further, the primary dispersion by using the bead mill is performed for 2 hours and the secondary dispersion by using the paint shaker is performed for 2 hours.

7. Formation of Coating Solution G for Forming a Intermediate Layer

The coating solution G for forming a intermediate layer is formed in the same manner as the coating solution F for forming a intermediate layer except that the primary dispersion by using the bead mill is performed for 1 hour and the secondary dispersion by using the paint shaker is performed for 1 hour.

8. Formation of Coating Solution H for Forming a Intermediate Layer

The coating solution H for forming a intermediate layer is formed in the same manner as the coating solution A for forming a intermediate layer except for the following steps. That is, as titanium oxide to which surface treatment is applied with alumina and silica and, thereafter, surface treatment is applied with methylhydrogenpolysiloxane, 250 parts by weight of SMT-02 (number average primary particle size: 10 nm) is added. MT-05 (number average primary particle size: 10 nm) which constitutes titanium oxide to which surface treatment is applied only with alumina and silica is not added to the coating solution H for forming a intermediate layer.

9. Formation of Coating Solution I for Forming a Intermediate Layer

The coating solution I for forming a intermediate layer is formed in the same manner as the coating solution H for forming a intermediate layer except that the primary dispersion by using the bead mill is performed for 0.5 hours and the secondary dispersion by using the paint shaker is performed for 0.5 hours.

10. Formation of Coating Solution J for Forming a Intermediate Layer

The coating solution J for forming a intermediate layer is formed in the same manner as the coating solution H for forming a intermediate layer except for the following steps. That is, the primary dispersion by using the bead mill is performed for 1 hour and the secondary dispersion by using the paint shaker is performed for 0.5 hours.

Here, the summary of compositions and manufacturing steps of the coating solution for forming a intermediate layers A to J are shown in Table 1.

11. Formation of Coating Solution K for Forming a Intermediate Layer

The coating solution K for forming a intermediate layer is formed in the same manner as the coating solution A for forming a intermediate layer except for the following steps. That is, as Amilan CM8000 which is preliminarily dissolved in a solvent and is added in the primary dispersion, 35 parts by weight of Amilan CM8000 which is dissolved in 140 parts by weight of methanol and 35 parts by weight of butanol is used and, as Amilan CM8000 which is preliminarily dissolved in a solvent and is added in the secondary dispersion, 65 parts by weight of Amilan CM8000 which is dissolved in 260 parts by weight of methanol and 65 parts by weight of butanol is used. Further, mixing in the secondary dispersion is performed by using the bead mill in the same manner as in the primary dispersion.

12. Formation of Coating Solution L for Forming a Intermediate Layer

The coating solution L for forming a intermediate layer is formed in the same manner as the coating solution A for forming a intermediate layer except that as the media of the bead mill which is used in the primary dispersion, zirconia balls having a diameter of 1 mm are used and mixing in the secondary dispersion is performed by using the bead mill in the same manner as the primary dispersion.

13. Formation of Coating Solution M for Forming a Intermediate Layer

The coating solution M for forming a intermediate layer is formed in the following steps. That is, as Amilan CM8000 which is preliminarily dissolved in a solvent and is added in the primary dispersion, 60 parts by weight of Amilan CM8000 which is dissolved in 240 parts by weight of methanol and 60 parts by weight of butanol is used, while, as the media of the bead mill which is used in the primary dispersion, zirconia balls having a diameter of 1 mm are used. Still further, as Amilan CM8000 which is preliminarily dissolved in a solvent and is added in the secondary dispersion, 40 parts by weight of Amilan CM8000 which is dissolved in 160 parts by weight of methanol and 40 parts by weight of butanol is used and mixing in the secondary dispersion is performed by using the bead mill in the same manner as in the primary dispersion. Except these steps, the coating solution M for forming a intermediate layer is formed in the same manner as the coating solution A for forming a intermediate layer.

14. Formation of Coating Solution N for Forming a Intermediate Layer

The coating solution N for forming a intermediate layer is formed such that the same kind and the same quantity of titanium oxide which is used in the coating solution A for forming a intermediate layer, 1000 parts by weight of methanol, and 250 parts by weight of butanol, 100 parts by weight of Amilan CM8000 are mixed by using the bead mill (media: zirconia balls having a diameter of 1 mm) for 10 hours without performing the secondary dispersion.

15. Formation of Coating Solution O for Forming a Intermediate Layer

The coating solution O for forming a intermediate layer is formed such that the same kind and the same quantity of titanium oxide which is used in the coating solution A for forming a intermediate layer, 600 parts by weight of methanol, and 150 parts by weight of butanol are mixed by using the bead mill (media: zirconia balls having a diameter of 0.5 mm) for 1 hour thus producing a primary dispersion solution.

Subsequently, 100 parts by weight of CM8000 which is preliminarily dissolved in 400 parts by weight of methanol and 100 parts by weight of butanol is added and, thereafter, the materials are mixed for 1 hour by using the bead mill in the same manner as the first dispersion to perform the secondary dispersion thus producing the coating solution O for forming a intermediate layer.

16. Formation of Coating Solution P for Forming a Intermediate Layer

The coating solution P for forming a intermediate layer is formed in the following steps. That is, as Amilan CM8000 which is preliminarily dissolved in a solvent and is added in the primary dispersion, 10 parts by weight of Amilan CM8000 which is dissolved in 40 parts by weight of methanol and 10 parts by weight of butanol is used, while, as the media of the bead mill which is used in the primary dispersion, zirconia balls having a diameter of 1 mm are used. Still further, as Amilan CM8000 which is preliminarily dissolved in a solvent and is added in the secondary dispersion, 90 parts by weight of Amilan CM8000 which is dissolved in 360 parts by weight of methanol and 90 parts by weight of butanol is used and mixing in the secondary dispersion is performed by using the bead mill in the same manner as in the primary dispersion. Except for these steps, the coating solution P for forming a intermediate layer is formed in the same manner as the coating solution A for forming a intermediate layer.

17. Formation of Coating Solution Q for Forming a Intermediate Layer

The coating solution Q for forming a intermediate layer is formed such that as titanium oxide to which surface treatment is applied with alumina and silica and, thereafter, surface treatment is applied with methylhydrogenpolysiloxane, 250 parts by weight of SMT-02 (number average primary particle size: 10 nm) is added, while MT-05 (number average primary particle size: 10 nm) which constitutes titanium oxide to which surface treatment is applied only with alumina and silica, is not added to the coating solution Q for forming a intermediate layer. Further, such titanium oxide, 500 parts by weight of methanol, 125 parts by weight of butanol, 10 parts by weight of Amilan CM8000 which is preliminarily dissolved in 40 parts by weight of methanol and 10 parts by weight of butanol are added, and, thereafter, the materials are mixed by using the bead mill (media: zirconia balls having a diameter of 0.5 mm) for 1 hour thus producing the primary dispersion solution.

Subsequently, 90 parts by weight of Amilan CM8000 which is preliminarily dissolved in 460 parts by weight of methanol and 115 parts by weight of butanol is added and, thereafter, these materials are mixed for 1 hour by using the bead mill in the same manner as the first dispersion to perform the secondary dispersion thus producing the coating solution Q for forming a intermediate layer.

Here, the summary of compositions and manufacturing steps of the coating solution for forming a intermediate layers K to Q is shown in Table 2.

TABLE 1

| | primary dispersion | | | | | secondary dispersion | |
|---|---|---|---|---|---|---|---|
| | | | | resin | | resin | |
| | | | | solution | | solution | |
| | titanium oxide 1 | titanium oxide 2 | | amilan/ | | amilan/ | |
| | kind/particle | kind/particle | methanol/ | methanol/ | | methanol/ | |
| | size (nm)/ | size (nm)/ | butanol | butanol | mixing | butanol | mixing |
| coating | amount (parts | amount (parts | (parts by | (parts by | method/mixing | (parts by | method/mixing |
| solution | by weight) | by weight) | weight) | weight) | time (time) | weight) | time (time) |
| A | SMT-02/10/150 | MT-05/10/100 | 600/150 | 50/200/50 | bead mill (particle | 50/200/50 | paint shaker/1 |
| | | | | | size: 0.5 mm)/1 | | |
| B | | | | | bead mill (particle | | paint shaker/2 |
| | | | | | size: 0.5 mm)/2 | | |
| C | | | | | bead mill (particle | | paint shaker/0.5 |
| | | | | | size: 0.5 mm)/1 | | |
| D | | | | | bead mill (particle | | paint shaker/1 |
| E | | | | | size: 0.5 mm)/0.5 | | paint shaker/0.5 |
| F | SMT-500SAS/35/150 | MT-600BS/35/100 | | | bead mill (particle | | paint shaker/2 |
| | | | | | size: 0.5 mm)/2 | | |
| G | | | | | bead mill (particle | | paint shaker/1 |
| H | SMT-02/10/250 | — | | | size: 0.5 mm)/1 | | |
| I | | | | | bead mill (particle | | paint shaker/0.5 |
| | | | | | size: 0.5 mm)/0.5 | | |
| J | | | | | bead mill (particle | | |
| | | | | | size: 0.5 mm)/1 | | |

TABLE 2

| | primary dispersion | | | | | secondary dispersion | |
|---|---|---|---|---|---|---|---|
| | | | | resin | | resin | |
| | | | | solution | | solution | |
| | titanium oxide 1 | titanium oxide 2 | | amilan/ | | amilan/ | |
| | kind/particle | kind/particle | methanol/ | methanol/ | | methanol/ | |
| | size (nm)/ | size (nm)/ | butanol | butanol | mixing | butanol | mixing |
| coating | amount (parts | amount (parts | (parts by | (parts by | method/mixing | (parts by | method/mixing |
| solution | by weight) | by weight) | weight) | weight) | time (time) | weight) | time (time) |
| K | SMT-02/10/150 | MT-05/10/100 | 600/150 | 35/140/35 | bead mill (particle | 65/260/65 | bead mill (particle |
| | | | | | size: 0.5 mm)/1 | | size: 0.5 mm)/1 |
| L | | | | 50/200/50 | bead mill (particle | 50/200/50 | bead mill (particle |
| M | | | | 60/240/360 | size: 1 mm)/1 | 40/160/40 | size: 1 mm)/1 |
| N | | | 1000/250 | 100/—/— | bead mill (particle | — | — |
| | | | | | size: 1 mm)/10 | | |
| O | | | 600/150 | — | bead mill (particle | 100/400/100 | bead mill (particle |
| | | | | | size: 0.5 mm)/1 | | size: 0.5 mm)/1 |
| P | | | | 10/40/10 | bead mill (particle | 90/360/90 | bead mill (particle |
| | | | | | size: 1 mm)/1 | | size: 1 mm)/1 |
| Q | SMT-02/10/250 | — | 500/125 | | bead mill (particle | 90/460/115 | bead mill (particle |
| | | | | | size: 0.5 mm)/1 | | size: 0.5 mm)/1 |

### Example 1

1. Formation of Multi-layer Type Electrophotographic Photoconductor

(1) Formation of Intermediate Layer

In example 1, the obtained coating solution A for forming a intermediate layer is filtered using a 5 micron filter and, thereafter, an aluminum base body (support base body) having a diameter of 30 mm and a length of 238.5 mm is dipped in the obtained coating solution for forming a intermediate layer at a speed of 5 mm/sec with one end thereof directed upwardly thus coating the base body with the coating solution for forming a intermediate layer. Thereafter, curing treatment is applied on the support base body at a temperature of 130° C. for 30 minutes thus forming an intermediate layer having a film thickness of 2 μm.

(2) Formation of Photoconductor Layer

Next, 1 part by weight of tithanylphthalocyanine which is manufactured in following steps and constitutes a charge generating agent, 1 part by weight of polyvinyl acetal resin (S-LEC KS-5 made by Sekisui Chemical Co., Ltd.) which constitute a binding resin, and 60 parts by weight of propylene glycol monomethyl ether as a dispersing medium and 20 parts by weight of tetrahydrofuran which constitute dispersion mediums are mixed and dispersed for 48 hours by using a ball mill thus forming a charge generating layer coating solution.

The obtained charge generating layer coating solution is filtered by a 3 micron filter and, thereafter, is applied to the intermediate layer by using a dip coating method and is dried at a temperature of 80° C. for 5 minutes thus forming the charge generating layer having a film thickness of 0.3 μm.

Next, 70 parts by weight of stilbene compound (HTM-1) which constitutes a hole transferring agent and is expressed by a following formula (1), 100parts by weight of polycarbonate resin (TEIJIN CHEMICALS LTD TS2020) which constitutes a binding resin, 460 parts by weight of tetrahydrofuran which constitutes a solvent are mixed and are dissolved thus forming the charge transfer layer coating solution.

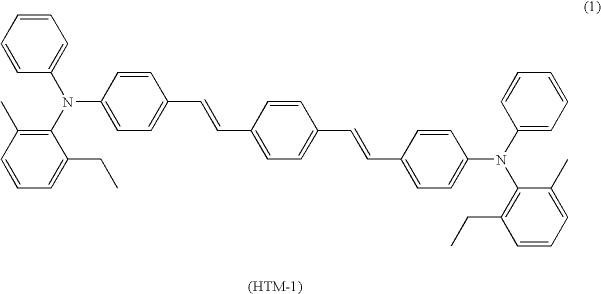

The obtained charge transfer layer coating solution is applied to the charge generating layer in the same manner as the charge generating layer coating solution and is dried at a temperature of 130° C. for 30 minutes to form the charge transfer layer having a film thickness of 20 μm on the charge of generating layer thus forming the multi-layer type electrophotographic photoconductor.

Tithanylphthalocyanine used here is synthesized by using following steps.

First of all, in a flask which is subjected to an argon displacement, 25 g of o-phthalonitrile, 28 g of titanium tetrabutoxide and 300 g of quinoline are added as reaction materials and, thereafter, the reaction materials are heated to 150° C. while being stirred using a stirring device.

Next, while distilling moisture which is generated from the reaction materials in the flask, the reaction materials are further heated to 215° C. Thereafter, keeping this temperature, the reaction materials are reacted each other for another 2 hours while being stirred.

After the reaction is finished, at a point of time that a reacted material in the flask is cooled to 150° C., the reacted material is taken out from the flask and is filtered using a glass filter. An obtained solid material is sequentially rinsed with N,N-dimethylformamide and methanol and, thereafter, the solid material is dried in vacuum whereby 24 g of violet-blue solid is obtained. (pretreatment before forming pigment)

Next, in a flask provided with a stirring device, 10 g of the obtained violet-blue solid, 100 ml of N,N-dimethylformamide are added and these materials are heated to 130° C. and stirring treatment is performed for 2 hours thus producing a reactive liquid.

Next, heating is stopped and the material is cooled to 23±1° C. and, thereafter, the reactive liquid is left still for 12 hours for performing a stabilization treatment.

Then, the stabilized reactive liquid is filtered by using a glass filter, and the obtained solid is further rinsed with methanol. Next, the reactive liquid is dried in vacuum thus producing 9.83 g of crude crystals of tithanylphthalocyanine compound.

Next, in a flask provided with a stirring device, 5 g of the obtained crude crystals of tithanylphthalocyanine and 100 ml of concentrated sulfuric acid are added and are uniformly dissolved.

Next, an obtained solution is dropped in water cooled with ice and, thereafter, the water is stirred at a room temperature for 15 minutes and, further, is left still for 30 minutes at 23±1° C. thus recrystallizing the solution.

Next, the recrystallized solution is filtered using the glass filter and the obtained solid is rinsed with water until the rinse liquid is neutralized. Thereafter, in a state that the obtained solid is not dried and the moisture is present in the obtained solid, the obtained solid is dispersed in 200 ml of chlorobenzen and the solution is heated to 50° C. and stirred for 10 hours.

Then, the obtained solution is filtered by using a glass filter and the obtained solid is dried in vacuum at a temperature of 50° C. for 5 hours thus producing 4.1 g of blue powder as tithanylphthalocyanine crystal.

Here, with respect to the obtained tithanylphthalocyanine, it is confirmed that, in an initial stage and even after the tithanylphthalocyanine is dipped in 1,3-dioxiolane or tetrahydrofuran for 7 days, peaks are not generated at flag angles 2θ±0.2°=7.4° and 26.2° and that, except for a peak in the vicinity of 90° C. which is generated due to the evaporation of absorbed water, no peak is observed in change of crystal within a temperature range from 50° C. to 400° C.

2. Evaluation

(1) Dispersion State 1 of Titanium Oxide (State of Coating Solution for Forming a Intermediate Layer)

The dispersibility of titanium oxide in the coating solution for forming a intermediate layer before the intermediate coating solution is applied to the support base body is observed with naked eyes and is valuated with reference to following criteria. The obtained results are shown in Table 3.
G: An aggregated body of titanium oxide due to poor dispersion is not observed.
F: An aggregated body of titanium oxide due to poor dispersion is slightly observed.
B: An aggregated body of titanium oxide due to poor dispersion is observed.
   (2) Dispersion State 2 of Titanium Oxide (ΔL Value, Δa Value, Δb Value)

The L value (L₁) with respect to light having a wavelength of 550 nm in the support base body on which the obtained intermediate layer (reference thickness: 2 μm) is stacked is measured by a color-difference meter (CM1000 made by MINOLTA (LTD)). Next, the L value (L₂) with respect to light having a wavelength of 550 nm in the support base body on which the obtained intermediate layer (reference thickness: 2 μm) is not stacked is measured in the same manner.

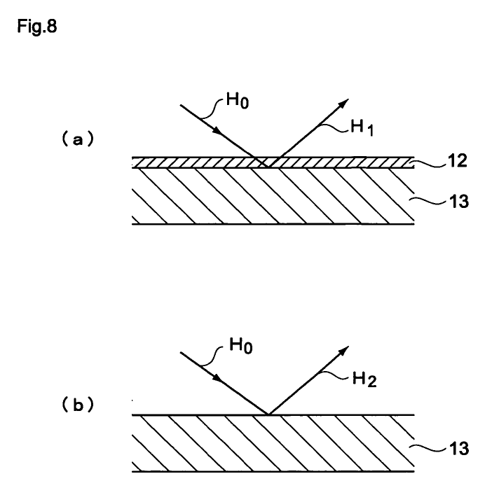

That is, to explain the dispersed state more specifically in conjunction FIG. 8(a) and FIG. 8(b), FIG. 8(a) shows a state in which the intermediate layer 12 is stacked on the support base body 13 and FIG. 8(b) shows a state in which only the support base body 13 is present. Here, symbol H₀ in FIG. 8(a) and FIG. 8(b) indicates light (incident light) radiated to each support base body and symbols H₁ and H₂ indicate reflection lights against the incident lights irradiated to the respective support base bodies.

Accordingly, to acquire the L value (ΔL value) of the intermediate layer in the intermediate layer by eliminating the influence of the support base body, the L value (L₂) of H₂ in which reflection light from the single support base body may be present is subtracted from the L value (L₁) of H₁ in which the reflection lights from the intermediate layer and the support base body are mixed so as to obtain a correction value.

That is, based on the obtained L values (L₁, L₂), the corrected L value (ΔL value) of the intermediate layer is calculated by using a following formula (1).

Further, simultaneously with the measurement of the L value is measured, the a value and the b value are also measured in the same manner as the L value. Further, the Δa value and the Δb value are calculated in the same manner that the ΔL value is calculated based on the obtained L values (L₁, L₂). The obtained result is shown in Table 3.

Here, by measuring the ΔL value, the Δa value and the Δb value, it is possible to easily confirm the dispersion state of the titanium oxide in the intermediate layer. That is, it is possible to easily confirm properties such as the fogging ID and the brightness potential when the electrophotographic photoconductor which includes the intermediate layer is used.
ΔL=L₁-L₂ (1)
(3) Dispersion State 3 of Titanium Oxide (Reflection Absorbance (Δa Value))

The reflection absorbance (A₁) with respect to light having a wavelength of 550 nm in the support base body on which the obtained intermediate layer (reference thickness: 2 μm) is stacked is measured by using a color-difference meter (CM1000 made by MINOLTA (LTD)). Next, the reflection absorbance (A₂) with respect to light having a wavelength of 550 nm in the support base body on which the obtained intermediate layer is not stacked is measured in the same manner.

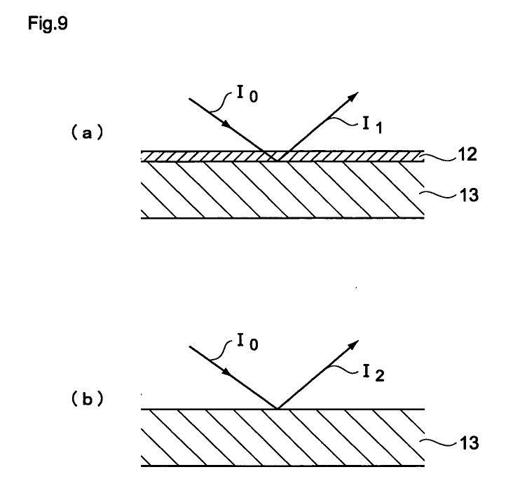

That is, to explain the dispersed state more specifically in conjunction FIG. 9(a) and FIG. 9(b), FIG. 9(a) shows a state in which the intermediate layer 12 is stacked on the support base body 13 and FIG. 9(b) shows a state in which only the support base body 13 is present. Here, symbol I₀ in FIG. 9(a) and FIG. 9(b) indicates intensity of light (incident light) radiated to each support base body and symbols I₁ and I₂ indicate intensities of reflection lights corresponding to the incident lights irradiated to the respective support base bodies. Accordingly, to acquire the reflection absorbance (ΔA value) of the intermediate layer by eliminating the influence of the support base body, the reflection absorbance of A₂ in which the reflection light from single support base body is present may be subtracted from the reflection absorbance of A₁ in which the reflection lights from the intermediate layer and the support base body are mixed.

Accordingly, based on the obtained reflection absorbance values (A₁, A₂), the reflection absorbance (ΔA value) of the intermediate layer is calculated by using a following formula (2) and, at the same time, the reflection absorbance (ΔA values) are compared with each other based on following criteria and the dispersibility of titanium oxide particles in the intermediate layer is evaluated. The obtained result is shown in Table 3.

Here, the reflection absorbance (A₁) in FIG. 9(a) is calculated by using a following formula (3) and, in the same manner, the reflection absorbance (A₂) in FIG. 9(b) is calculated using a following formula (4). It is understood that corresponding to the decrease of the reflection absorbance (ΔA value) of the intermediate layer, the dispersion of light in the intermediate layer is decreased. That is, the dispersibility of the titanium oxide particles in the intermediate layer is increased.
ΔA=A₁-A₂ (2)
A₁=−Log I₁/I₀ (3)
A₂=−Log I₂/I₀ (4)
G: A≦0.055
F: 0.055<A≦0.08
B: A>0.08
   (4) Measurement of Brightness Potential

The obtained electrophotographic photoconductor is mounted on a printer (Microline-22N made by Oki Data Corporation) which adopts a negative charge reverse development process and the brightness potential measurement is performed under a low-temperature and low-moisture condition.

That is, after 1000 sheets are printed under a low-temperature and low-moisture condition (temperature: 10° C.-moisture: 20%), a potential at a developing position is taken as the brightness potential (V). Further, based on the obtained brightness potential values, in accordance with following references, the sensitivity is evaluated. The obtained result is shown in Table 3. Here, as measured values of the brightness potentials, absolute values of the brightness potentials are indicated.
G: The absolute value of the brightness potential is less than 25V.
F: The absolute value of the brightness potential is equal to and more than 25V and less than 35V.
B: The absolute value of the brightness potential is equal to or more than 35V.
   (5) Fogging ID Evaluation

Further, the obtained electrophotographic photoconductor is mounted on the above-mentioned printer (Microline-22N made by Oki Data Corporation) which adopts a negative charge reverse development process and fogging ID evaluation is performed under a high-temperature and high-moisture atmosphere.

That is, after 100,000 sheets of image evaluation patterns are printed under a high-temperature and high-moisture atmosphere, fogging after 100,000 sheets are printed is evaluated in accordance with following criteria. Here, the fogging implies the difference obtained by subtracting ID in a white paper from ID in a white paper printing image.

Here, the ID in the white paper printing image and the ID in the white paper are measured by using a reflection density meter (TC-6D made by TOKYO DENSHOKU CO., LTD). To be more specific, the densities are measured at arbitrary 9 points on the white paper printing image and an average value of the densities is calculated and is used as the criterion in the evaluation of the fogging ID. The obtained result is shown in Table 3.
G: The density difference is less than 0.005.
F: The density difference is equal to or more than 0.005, and less than 0.010.
B: The density difference is equal to or more than 0.010.

### Examples 2 to 7 and Comparison Examples 1 to 3

In examples 2 to 7 and comparison examples 1 to 3, multi-layer type electrophotographic photoconductors are formed and are evaluated in the same manner as the example 1 except that, as shown in Table 3, coating solution for forming a intermediate layers B to J are respectively used as coating solution for forming a intermediate layers in forming the intermediate layer in the electrophotographic photoconductor. The obtained results are shown in Table 3.

TABLE 3

| | intermediate layer | | | | | | | | | | |
|---|---|---|---|---|---|---|---|---|---|---|---|
| | | | | | reflection absorbance | | | electric properties | | | |
| | | ΔL | Δa | Δb | (ΔA value) | | | brightness potential | | fogging ID | |
| | coating | value | value | value | measured | | liquid | measured | | measured | |
| | solution | (−) | (−) | (−) | value (−) | evaluation | state | value (V) | evaluation | value(−) | evaluation |
| example 1 | A | −2.8 | −1.11 | 3.88 | 0.032 | G | G | 15 | G | 0.003 | G |
| example 2 | B | −3 | −0.61 | 2.34 | 0.038 | G | G | 20 | G | 0.004 | G |
| example 3 | C | −3.7 | −0.57 | 2.2 | 0.053 | G | G | 18 | G | 0.003 | G |
| example 4 | F | −3.8 | −0.33 | 1.56 | 0.046 | G | G | 18 | G | 0.003 | G |
| example 5 | H | −2.1 | −0.55 | 0.99 | 0.024 | G | G | 19 | G | 0.002 | G |
| example 6 | I | −4.8 | 0.12 | −1.64 | 0.063 | F | F | 33 | F | 0.006 | F |
| example 7 | J | −4.5 | −0.33 | 7.3 | 0.064 | F | F | 30 | F | 0.007 | F |
| comparison | D | −5.3 | −1.6 | −0.35 | 0.072 | F | F | 41 | B | 0.006 | F |
| example 1 | | | | | | | | | | | |
| comparison | E | −5.1 | −0.23 | −3.5 | 0.085 | B | B | 38 | B | 0.011 | B |
| example 2 | | | | | | | | | | | |
| comparison | G | −6.5 | −0.85 | −0.56 | 0.091 | B | B | 37 | B | 0.021 | B |
| example 3 | | | | | | | | | | | |

### Examples 8 to 10 and Comparison Examples 4 to 7

In examples 8 to 10 and comparison examples 4 to 7, multi-layer type electrophotographic photoconductors are formed in the same manner as the example 1 except that, as shown in Table 4, coating solution for forming a intermediate layers K to Q are respectively used as coating solution for forming a intermediate layers in forming the intermediate layer in the electrophotographic photoconductor. Further, states, reflection absorbances (ΔA values), brightness potentials and fogging ID of the coating solution for forming a intermediate layers are respectively evaluated in the same manner as the example 1. The surfaces of the formed intermediate layers are also observed by using an electrophotographic microscope and evaluated as follows.

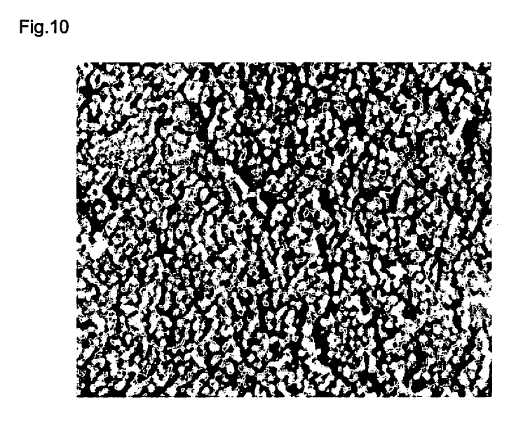

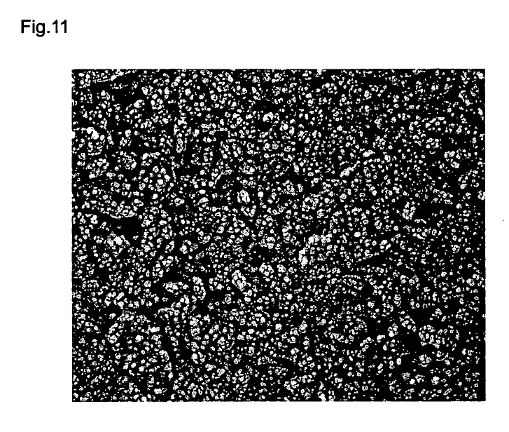

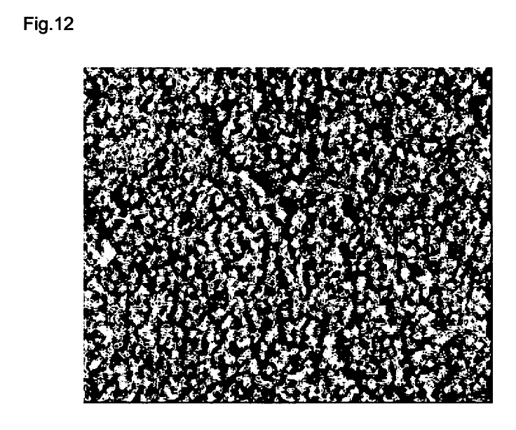

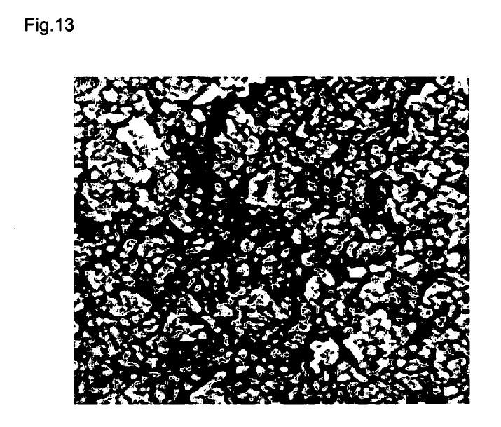

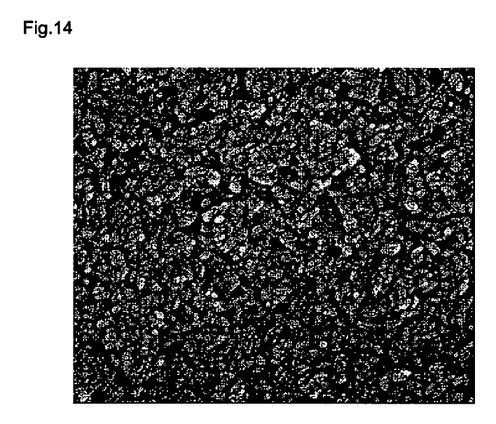

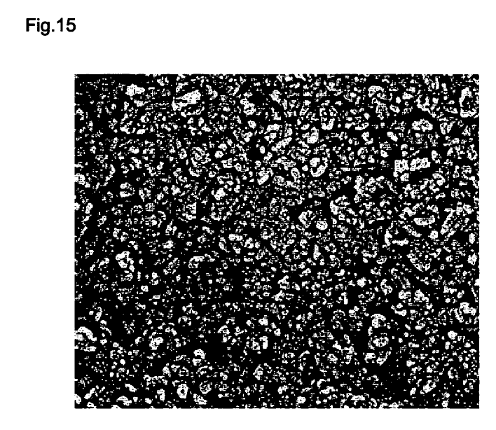

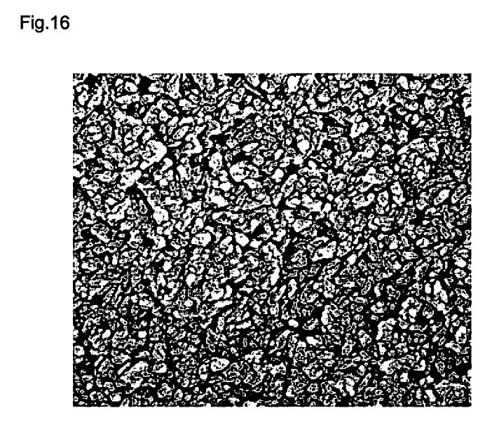

That is, the surfaces of the intermediate layers formed on the support base bodies are observed by using a scanning-type microscope JSM-7401F, FE-SEM made by JEOL and the dispersion state of titanium oxide is evaluated in accordance with following criterion. The obtained results are shown in Table 4. Further, images of surfaces of the intermediate layers observed by using the electronic microscope are shown in FIG. 10 to 16.
G: It is confirmed that the dispersion is uniform.
F: A few portions where dispersion is not uniform are observed.

B: It is confirmed that the dispersion is not uniform.

TABLE 4

| | intermediate layer | | | | | | | | |
|---|---|---|---|---|---|---|---|---|---|
| | | reflection absorbance | | | | electric characteristic | | | |
| | | (ΔA value) | | | electron | brightness potential | | fogging ID | |
| | coating | measured | | liquid | microscope | measured | | measured | |
| | solution | value (−) | evaluation | state | observation | value (V) | evaluation | value (−) | evaluation |
| example 8 | K | 0.027 | G | G | G | 15 | G | 0.003 | G |
| example 9 | L | 0.018 | G | G | G | 20 | G | 0.002 | G |
| example 10 | M | 0.041 | G | G | G | 18 | G | 0.005 | F |
| comparison | N | 0.112 | B | F | B | 38 | B | 0.028 | B |
| example 4 | | | | | | | | | |
| comparison | O | 0.092 | B | gel | F | — | — | — | — |
| example 5 | | | | state | | | | | |
| comparison | P | 0.072 | F | F | F | 40 | B | 0.016 | B |
| example 6 | | | | | | | | | |
| comparison | Q | 0.075 | F | G | F | 30 | F | 0.018 | B |
| example 7 | | | | | | | | | |

### Example 11

1. Formation of Single-layer-type Electrophotographic Photoconductor

(1) Formation of Intermediate Layer

In an example 11, an aluminum base body (support base body) having a diameter of 30 mm and a length of 254 mm is dipped in the coating solution A for forming a intermediate layer after the obtained coating solution for forming a intermediate layer is filtered using a 5 micron filter at a speed of 5 mm/sec with one end thereof divided upwardly thus applying the coating to the support base body. Thereafter, curing treatment is performed at a temperature of 130° C. for 30 minutes thus forming an intermediate layer having a film thickness of 2 μm.

(2) Formation of the Photoconductor Layer

Next, 5 parts by weight of tithanylphthalocyanine which constitutes the charge generating agent and is manufactured by the same procedures as the example 1, 70 parts by weight of compound (HTM-1) which is expressed by formula (1) and constitutes a hole transferring agent, 30 parts by weight of compound (ETM-1) which is expressed by formula (2) and constitutes an electron transfer agent, 100 parts by weight of polycarbonate (TEIJIN CHEMICALS LTD TS2020) which constitutes the binding resin are mixed with each other and dispersed together with 800 parts by weight of tetrahydrofuran by using an ultrasonic dispersing apparatus thus manufacturing a single-layer-type photoconductor layer coating solution.

Next, the obtained single-layer-type photoconductor layer coating solution is applied to the above-mentioned intermediate layer by using a dip coating method within 60 minutes after manufacturing the single-layer-type photoconductor layer coating solution and, thereafter, the coated coating solution is subjected to heat treatment at a temperature of 130° C. for 30 minutes thus forming a single layer type electrophotographic photoconductor having a film thickness of 25 μm. 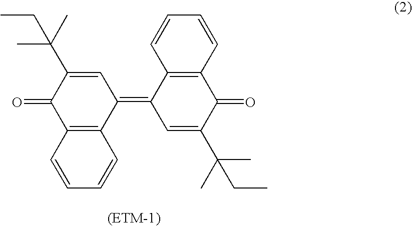
2. Evaluation
(1) Evaluation of Dispersion State of the Titanium Oxide

Further, the evaluation of the dispersion states of the titanium oxide in the coating solution for forming a intermediate layer and the intermediate layer is performed in the same manner as the example 1. The obtained result is shown in Table 5.

(2) Measurement of Brightness Potential Change

Further, the brightness potential change is measured as follows. That is, as an image forming apparatus on which the electrophotographic photoconductor is mounted, a printer (FS1010 made by Kyocera Mita Corporation) which adopts a positive charge reverse development process is used, the measurement is performed by setting potentials at an initial developing position and a developing position after 1000 sheets are printed under a low-temperature and low-moisture condition (temperature: 10° C.-moisture: 20%) as brightness potentials (V). Next, the initial brightness potential (V) is subtracted from the brightness potential (V) after 1000 sheets are printed thus obtaining the brightness potential change (V). Further, based on the value of the obtained brightness potential change, the sensitivity is evaluated in accordance with following criterion.
G: The brightness potential change is less than 10V.
F: The brightness potential change is equal to or more than 10V, and less than 20V.
B: The brightness potential change is equal to or more than 20V.
   (3) Fogging ID Evaluation

Further, the fogging ID is evaluated in the same manner and based on the same criterion as the example 1 except that, as the image forming apparatus on which the electrophotographic photoconductor is mounted, the printer (FS1010 made by Kyocera Mita Corporation) which adopts the positive charge reverse development process is used. The obtained result is shown in Table 5.

### Examples 12 to 17 and Comparison Examples 8 to 10

In examples 12 to 17 and comparison examples 8 to 10, single layer type electrophotographic photoconductors are formed and are evaluated in the same manner as the example 11 except that, as shown in Table 5, coating solution for forming a intermediate layers B to J are respectively used as coating solution for forming a intermediate layers in forming the intermediate layer in the single layer type electrophotographic photoconductor. The obtained results are shown in Table 5.

TABLE 5

| | intermediate layer | | | | | | | electric characteristic | | | |
|---|---|---|---|---|---|---|---|---|---|---|---|
| | | | | | reflection absorbance | | | brightness potential | | | |
| | | ΔL | Δa | Δb | (ΔA value) | | | change | | fogging ID | |
| | coating | value | value | value | measured | | liquid | measured | | measured | |
| | solution | (−) | (−) | (−) | value(−) | evaluation | state | value (V) | evaluation | value(−) | evaluation |
| example 11 | A | −2.8 | −1.11 | 3.88 | 0.032 | G | G | 6 | G | 0.003 | G |
| example 12 | B | −3 | −0.61 | 2.34 | 0.038 | G | G | 8 | G | 0.004 | G |
| example 13 | C | −3.7 | −0.57 | 2.2 | 0.053 | G | G | 6 | G | 0.003 | G |
| example 14 | F | −3.8 | −0.33 | 1.56 | 0.046 | G | G | 6 | G | 0.003 | G |
| example 15 | H | −2.1 | −0.55 | 0.99 | 0.024 | G | G | 5 | G | 0.002 | G |
| example 16 | I | −4.8 | 0.12 | −1.64 | 0.063 | F | F | 11 | F | 0.006 | F |
| example 17 | J | −4.5 | −0.33 | 7.3 | 0.064 | F | F | 12 | F | 0.007 | F |
| comparison | D | −5.3 | −1.6 | −0.35 | 0.072 | F | F | 20 | B | 0.012 | B |
| example 8 | | | | | | | | | | | |
| comparison | E | −5.1 | −0.23 | −3.5 | 0.085 | B | B | 21 | B | 0.011 | B |
| example 9 | | | | | | | | | | | |
| comparison | G | −6.5 | −0.85 | −0.56 | 0.091 | B | B | 29 | B | 0.021 | B |
| example 10 | | | | | | | | | | | |

### INDUSTRIAL APPLICABILITY

According to the electrophotographic photoconductor of the present invention, by providing the intermediate layer which sets the L value or the reflection absorbance to the value which falls within the predetermined range, it is possible to reduce the generation of fogging in the electrophotographic photoconductor under a high-temperature and high-moisture condition.

Further, according to the manufacturing method of the electrophotographic photoconductor of the present invention, the preservation stability of the coating solution for forming a intermediate layer or the like is enhanced and hence, it is possible to easily and stably manufacture not only the intermediate layer but also the photoconductor layer. Accordingly, the economical acquisition of the electrophotographic photoconductor which possesses the stable electric properties can be realized.

What we claim is:

1. An electrophotographic photoconductor comprising a support base body, an intermediate layer and a photoconductor layer, wherein the intermediate layer contains titanium oxide and a binding resin, and a ΔL value of the intermediate layer satisfies a following relationship formula (1) or a ΔA value of the intermediate layer satisfies a following relationship formula (2).
−5.0≦ΔL≦0 (1)
ΔA≦0.055 (2)
ΔL value: a value which is obtained by subtracting an L value (a parameter value which is measured by a color-difference meter in accordance with JIS Z 8722) which is measured with respect to a single support base body from the L value which is measured in a state that the intermediate layer is formed on the support base body.
ΔA value: a value which is obtained by subtracting reflection absorbance (a parameter value which is measured by a color-difference meter) which is measured with respect to a single support base body from the reflection absorbance which is measured in a state that the intermediate layer is formed on the support base body.

2. The electrophotographic photoconductor according to claim 1, wherein a value (Δa value) which is obtained by subtracting a a value (a parameter value which is measured by a color-difference meter in accordance with JIS Z 8722) of the intermediate layer which is measured with respect to a single support base body from the a value which is measured in a state that the intermediate layer is formed on the support base body is set to a value which falls within a range from −1.2 to 0.

3. The electrophotographic photoconductor according to claim 1, wherein a value (Δb value) which is obtained by subtracting a b value (a parameter value which is measured by a color-difference meter in accordance with JIS Z 8722) of the intermediate layer which is measured with respect to a single support base body from the b value which is measured in a state that the intermediate layer is formed on the support base body is set to a value which falls within a range from 0 to 10.

4. The electrophotographic photoconductor according to claim 1, wherein an amount of titanium oxide contained in the intermediate layer is set to a value which falls within a range from 150 to 350 parts by weight with respect to 100 parts by weight of the binding resin.

5. The electrophotographic photoconductor according to claim 1, wherein an average primary particle size of titanium oxide contained in the intermediate layer is set to a value which falls within a range from 0.001 to 0.1 μm.

6. The electrophotographic photoconductor according to claim 1, wherein titanium oxide contained in the intermediate layer is covered with an organosilicone compound.

7. The electrophotographic photoconductor according to claim 1, wherein an average molecular weight of the binding resin contained in the intermediate layer is set to a value which falls within a range from 1000 to 50000.

8. The electrophotographic photoconductor according to claim 1, wherein a thickness of the intermediate layer is set to a value which falls within a range from 0.1 to 50 μm.

9. The electrophotographic photoconductor according to claim 1, wherein the electrophotographic photoconductor is a multi-layer type electrophotographic photoconductor in which an intermediate layer, a charge generating layer and a charge transferring layer are sequentially stacked on a support base body.

10. A manufacturing method of an electrophotographic photoconductor comprising a support base body, an intermediate layer and a photoconductor layer, wherein the manufacturing method of the electrophotographic photoconductor includes a step for manufacturing the coating solution for forming the intermediate layer by dispersing titanium oxide in a binding resin solution containing a binding resin and an organic solvent, and a step for forming the intermediate layer in which a ΔL value of the intermediate layer satisfies a following relationship formula (1) or a ΔA value of the intermediate layer satisfies a following relationship formula (2) by using the coating solution for forming the intermediate layer.
−5.0≦ΔL≦0 (1)
ΔA≦0.055 (2)
ΔL value: a value which is obtained by subtracting an L value (a parameter value which is measured by a color-difference meter in accordance with JIS Z 8722) which is measured with respect to a single support base body from the L value which is measured in a state that the intermediate layer is formed on the support base body.
ΔA value: a value which is obtained by subtracting reflection absorbance (a parameter value which is measured by a color-difference meter) which is measured with respect to a single support base body from the reflection absorbance which is measured in a state that the intermediate layer is formed on the support base body.
